(19) United States
(12) Patent Application Publication
(10) Pub. No.: US 2024/0320441 A1
(43) Pub. Date: Sep. 26, 2024

(54) Natural Language Processing Dialog Methods and Systems for Virtual Scenes

(71) Applicant: Tencent Technology (Shenzhen) Company Limited, Shenzhen (CN)

(72) Inventors: Honghua Zhou, Shenzhen (CN); Yixian Liu, Shenzhen (CN); Yipeng Yu, Shenzhen (CN); Xinhua Zhou, Shenzhen (CN); Yuqi Zhang, Shenzhen (CN); Ziyun Wang, Shenzhen (CN); Zhuoni Jie, Shenzhen (CN)

(21) Appl. No.: 18/678,250

(22) Filed: May 30, 2024

Related U.S. Application Data
(63) Continuation of application No. PCT/CN2023/116503, filed on Sep. 1, 2023.

(30) Foreign Application Priority Data
Sep. 30, 2022 (CN) 202211207306.5

(51) Int. Cl. G06F 40/35; G06F 40/295; G06N 20/00

(52) U.S. Cl. CPC G06F 40/35; G06F 40/295; G06N 20/00

(57) ABSTRACT

This application provides a dialog processing method and apparatus for a virtual scene, an electronic device, a storage medium, and a computer program product; and the method includes: invoking, based on at least one input statement, field dialog models respectively corresponding to at least one participating object of a current round to perform dialog generation, to obtain a plurality of output statements of each participating object; invoking, based on each output statement, a general dialog model to perform quality prediction, to obtain a quality parameter of each output statement, the general dialog model being obtained through training based on a dialog sample in a general field; and selecting a dialog statement of the current round from the plurality of output statements based on the quality parameter of each output statement.

### CROSS REFERENCE TO RELATED APPLICATIONS

This application claims priority to PCT Application PCT/CN2023/116503, filed Sep. 1, 2023, which claims priority to Chinese Patent Application No. 202211207306.5 filed on Sep. 30, 2022, each of which is incorporated herein by reference in its entirety.

### FIELD

This application relates to computer technologies, and in particular, to a natural language processing dialog method and apparatus for a virtual scene, an electronic device, a computer program product, and a computer storage medium.

### BACKGROUND

Nature language processing (NLP) is an important direction in the fields of computer science and artificial intelligence. NLP studies various theories and methods for implementing effective communication between human and computers through natural languages. NLP relates to natural languages, namely, languages used by people in daily life, and is closely related to linguistic studies. In addition, NLP relates to an important technology of model training in the fields of computer science and math, and artificial intelligence. A pre-trained model is developed from a large language model (LLM) in the field of NLP. After fine-tuning, the LLM may be widely used in a downstream task. NLP technologies usually include text processing, semantic understanding, machine translation, robot question answering, knowledge graphs, and other technologies. The NLP technologies are applicable to text generation processing in a virtual scene.

By using a game virtual scene as an example, to support a game plot, a large amount of dialog content between virtual objects is needed in a game. Manual editing of the dialog content is more expensive and less efficient. However, there is a case that dialog content generated with help of artificial intelligence is of low quality. In related technologies, currently there is no good solution for generating high-quality dialog content between a plurality of virtual objects.

### SUMMARY

Aspects of this application provide a dialog processing method and apparatus for a virtual scene, an electronic device, a computer-readable storage medium, and a computer program product, which can improve quality of a generated dialog of a virtual object in a particular field.

Technical solutions of the aspects of this application are implemented as follows:

An aspect of this application provides a dialog processing method for a virtual scene, the method being performed by an electronic device, the virtual scene including a plurality of virtual objects participating in a current dialog, each virtual object corresponding to a field dialog model, the field dialog model being obtained through training based on dialog samples in a particular field, and the method including:

invoking, based on at least one input statement, a field dialog model corresponding to at least one participating virtual object of a current round of the current dialog to perform dialog generation, to obtain a plurality of output statements for each participating virtual object, wherein the at least one participating virtual object is other than a speaking virtual object of a previous round of the dialog;
invoking, based on each output statement, a general dialog model to perform quality prediction, to obtain a quality parameter of each output statement, the general dialog model being obtained through training based on dialog samples in a general field; and
selecting a dialog statement of the current round from the plurality of output statements based on the quality parameter of each output statement.

An aspect of this application provides a dialog processing apparatus for a virtual scene, the virtual scene including a plurality of virtual objects participating in a current dialog, each virtual object corresponding to a field dialog model, the field dialog model being obtained through training based on dialog samples in a particular field, and the apparatus including:
a dialog generation module, configured to invoke, based on at least one input statement, a field dialog model respectively corresponding to at least one participating object of a current round to perform dialog generation, to obtain a plurality of output statements of each participating object, the at least one participating object being a virtual object other than a speaking object of a previous round in the plurality of virtual objects;
a quality detection module, configured to invoke, based on each output statement, a general dialog model to perform quality prediction, to obtain a quality parameter of each output statement, the general dialog model being obtained through training based on dialog samples in a general field; and
the quality detection module being configured to select a dialog statement of the current round from the plurality of output statements based on the quality parameter of each output statement.

An aspect of this application provides an electronic device, including:
a memory, configured to store computer-executable instructions; and
a processor, configured to implement, when executing the computer-executable instructions stored in the memory, the dialog processing method for a virtual scene according to the aspect of this application.

An aspect of this application provides a computer-readable storage medium storing computer-executable instructions, for implementing, when executed by a processor, the dialog processing method for a virtual scene according to the aspect of this application.

An aspect of this application provides a computer program product, including a computer program or computer-executable instructions, the computer program or the computer-executable instructions, when executed by a processor, implementing the dialog processing method for a virtual scene according to the aspect of this application.

The aspects of this application have the following beneficial effects:

Configuring a field dialog model for each virtual object increases richness of a dialog statement corresponding to each virtual object, avoids many repeated statements in dialog content, and improves quality of the dialog content. By configuring the field dialog model, correlation between generated dialog content and a virtual scene is improved. In each round of a dialog, for a plurality of output statements that are generated by invoking a field dialog model in a particular field, quality evaluation is performed through a general dialog model. In this way, it is ensured that a high-quality output dialog is selected as a dialog statement of a corresponding round. In addition, dialog data of a current round is used as an input statement of a next round, which is for guiding dialog generation of the next round, and improving correlation and a fluency degree between dialogs of different rounds, thereby improving overall quality of the dialog content, so that the dialog content of the virtual object is more in line with a requirement of the virtual scene.

### BRIEF DESCRIPTION OF THE DRAWINGS

FIG. 1 is a schematic diagram of an application mode of a dialog processing method for a virtual scene according to one or more illustrative aspects described herein.

FIG. 2 is a schematic diagram of a structure of a server 200 according to one or more illustrative aspects described herein.

FIG. 3A is a first schematic flowchart of a dialog processing method for a virtual scene according to one or more illustrative aspects described herein.

FIG. 3B is a second schematic flowchart of a dialog processing method for a virtual scene according to one or more illustrative aspects described herein.

FIG. 3C is a third schematic flowchart of a dialog processing method for a virtual scene according to one or more illustrative aspects described herein.

FIG. 3D is a fourth schematic flowchart of a dialog processing method for a virtual scene according to one or more illustrative aspects described herein.

FIG. 3E is a fifth schematic flowchart of a dialog processing method for a virtual scene according to one or more illustrative aspects described herein.

FIG. 3F is a sixth schematic flowchart of a dialog processing method for a virtual scene according to one or more illustrative aspects described herein.

FIG. 3G is a seventh schematic flowchart of a dialog processing method for a virtual scene according to one or more illustrative aspects described herein.

FIG. 3H is an eighth schematic flowchart of a dialog processing method for a virtual scene according to one or more illustrative aspects described herein.

FIG. 4A is a ninth schematic flowchart of a dialog processing method for a virtual scene according to one or more illustrative aspects described herein.

FIG. 4B is a tenth schematic flowchart of a dialog processing method for a virtual scene according to one or more illustrative aspects described herein.

FIG. 4C is an eleventh schematic flowchart of a dialog processing method for a virtual scene according to one or more illustrative aspects described herein.

FIG. 4D is a twelfth schematic flowchart of a dialog processing method for a virtual scene according to one or more illustrative aspects described herein.

FIG. 4E is a thirteenth schematic flowchart of a dialog processing method for a virtual scene according to one or more illustrative aspects described herein.

FIG. 4F is a fourteenth schematic flowchart of a dialog processing method for a virtual scene according to one or more illustrative aspects described herein.

FIG. 4G is a fifteenth schematic flowchart of a dialog processing method for a virtual scene according to one or more illustrative aspects described herein.

FIG. 4H is a sixteenth schematic flowchart of a dialog processing method for a virtual scene according to one or more illustrative aspects described herein.

FIG. 5A is a schematic diagram of an application scene of a dialog processing method for a virtual scene according to one or more illustrative aspects described herein.

FIG. 5B is a seventeenth schematic flowchart of a dialog processing method for a virtual scene according to one or more illustrative aspects described herein.

FIG. 5C is an eighteenth schematic flowchart of a dialog processing method for a virtual scene according to one or more illustrative aspects described herein.

FIG. 6A is a nineteenth schematic flowchart of a dialog processing method for a virtual scene according to one or more illustrative aspects described herein.

FIG. 6B is a twentieth schematic flowchart of a dialog processing method for a virtual scene according to one or more illustrative aspects described herein.

FIG. 6C is a twenty-first schematic flowchart of a dialog processing method for a virtual scene according to one or more illustrative aspects described herein.

FIG. 7A is a schematic diagram of text according to one or more illustrative aspects described herein.

FIG. 7B is a schematic diagram of a first structure of a to-be-trained model according to one or more illustrative aspects described herein.

FIG. 7C is a schematic diagram of a second structure of a to-be-trained model according to one or more illustrative aspects described herein.

### DETAILED DESCRIPTION

To make the objectives, technical solutions, and advantages of this application clearer, the following describes this application in further detail with reference to the accompanying drawings. The described aspects are not to be considered as a limitation to this application. All other aspects obtained by a person of ordinary skill in the art without creative efforts shall fall within the protection scope of this application.

In the following descriptions, related “some aspects” describe a subset of all possible aspects. However, it may be understood that the “some aspects” may be the same subset or different subsets of all the possible aspects, and may be combined with each other without conflict.

In the following descriptions, the included term “first/second/third” is merely intended to distinguish similar objects but does not necessarily indicate specific order of an object. It may be understood that “first/second/third” is interchangeable in terms of a specific order or sequence if permitted, so that the aspects of this application described herein can be implemented in a sequence in addition to the sequence shown or described herein.

In the aspects of this application, related data such as user information or user feedback data is involved. When the aspects of this application are applied to a specific product or technology, user permission or consent is required to be obtained, and relevant collection, use, and processing of data are required to comply with relevant laws, regulations, and standards of relevant countries and regions.

Unless otherwise defined, meanings of all technical and scientific terms used in this specification are the same as those usually understood by a person skilled in the art to which this application belongs. Terms used in this specification are merely intended to describe objectives of the aspects of this application, but are not intended to limit this application.

Before the aspects of this application are further described in detail, nouns and terms involved in the aspects of this application are described. The nouns and terms provided in the aspects of this application are applicable to the following explanations.
(1) Virtual scene: It is a scene that is outputted by a device and is different from a real world. Visual perception of the virtual scene can be formed with the aid of naked eyes or devices, for example, by using two-dimensional images outputted by using a display screen, or by using three-dimensional images outputted by using a three-dimensional display technology such as three-dimensional projection, virtual reality, or augmented reality technology. In addition, a variety of perception simulating the real world such as auditory perception, tactile perception, olfactory perception, and motion perception can be further formed by using a variety of possible hardware. An example of the virtual scene is a virtual scene of a video game or computer game.
(2) In response to: It is configured for representing a condition or status on which one or more operations to be performed depend. When the condition or status is satisfied, the one or more operations may be performed in real time or after a set delay. Unless explicitly stated, there is no limitation on the order in which the plurality of operations are performed.
(3) Virtual object: It is an object that performs interaction in a virtual scene, and is an object being controlled by a user or a robot program (for example, a robot program based on artificial intelligence) and being capable of being stable, moving, and performing various behaviors in the virtual scene. For example, each role in a game may be performed by a virtual object.
(4) Dialog: It includes dialog statements of a plurality of rounds, where there are at least two virtual objects speaking in the dialog. The following uses a dialog as an example. Role A said “The weather is really nice today.”, and Role B said “It's suitable for going to the beach.”. Role A and Role B are virtual objects that speak.
(5) Round of dialog statement: It is also referred to as a dialog statement of a round (or a piece). A dialog statement of each round is a statement replied by a role (virtual object) to a dialog statement of a previous round, or is what is said for initiating a topic. For example, the following initial statement (a statement used as an opening remark): “What day is it today”, is what is said for initiating a topic; and “Today is Monday” is replied to the previous dialog statement.
(6) Softmax function: It is a function for transforming output values of different types into probability distributions that are in a range of [0, 1] and sum to 1. A formula of the softmax function is as follows:

$$Softmax ( {Z}_{i} ) = \frac{{e}^{{Z}_{i}}}{{\sum }_{c = 1}^{C} {e}^{{Z}_{c}}} .$$

Zᵢ is an output value of an i^{th} node, and C is a quantity of output nodes, namely, a type quantity for classification.
(7) General dialog data set: It is a large-scale corpus data set, for example, Wudao Corpus-Dialog, with around 2 TB text and 725 billion Chinese characters. The general dialog data set removes private information included in data, avoiding a privacy leak, and can be applied to natural language processing tasks of different types (such as language recognition and dialog prediction), and a trained model has strong generalization.
(8) Particular field: It is a language field with a particular style, for example, an ancient style field, or an Internet language style field.
(9) General field: It is a commonly used language field.
(10) Role information: It is information corresponding to a virtual object that expresses or speaks a dialog statement in text content. The role information may be a name or a pronoun (for example, “you” or “you all” that refers to an object) of a role. For example, a virtual object A speaks a dialog statement “Has Little C eaten?”, where Little C is the role information that refers to a virtual object C. For another example, a virtual object that participates in a dialog includes a virtual object A, a virtual object B, and a virtual object C. The virtual object A speaks a dialog statement “Hello everybody!”, and “everybody” herein is the role information, referring to the virtual object B and the virtual object C.

Aspects of this application provide a dialog processing method for a virtual scene, a dialog processing apparatus for a virtual scene, an electronic device, a computer-readable storage medium, and a computer program product, which can improve quality of a generated dialog of a virtual object in a particular field.

Illustrative applications of the electronic device according to the aspects of this application are described below. The electronic device according to the aspects of this application may be implemented as each type of user terminal such as a notebook computer, a tablet computer, a desktop computer, a set-top box, a mobile device (for example, a mobile phone, a portable music player, a personal digital assistant, a dedicated messaging device, or a portable game device), or an in-vehicle terminal, or may be implemented as a server. An illustrative application that the electronic device is implemented as a server is described below.

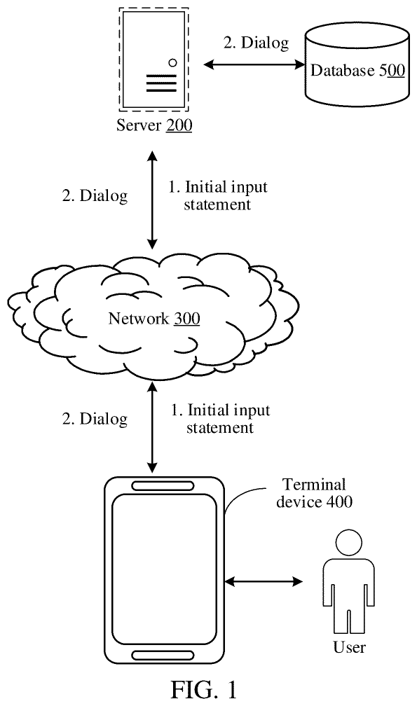

In some aspects, the dialog processing method for a virtual scene provided in the aspects of this application may be configured for plot editing of a game virtual scene. Before FIG. 1 is described, a game mode involved in a solution for collaborative implementation of a terminal device and a server is introduced first. The solution for collaborative implementation of a terminal device and a server mainly involves two game modes: respectively, a local game mode and a cloud game mode. The local game mode is that the terminal device and the server collaboratively run game processing logic. For operation instructions inputted by a gamer in the terminal device, a part of the operation instructions are processed by the terminal device running game logic, and another part of the operation instructions are processed by the server running the game logic. In addition, game logic processing run by the server is often more complex and requires more computing power. The cloud game mode is that game logic processing is completely run by the server, and a cloud server renders game scene data into audio and video streams, and transmits the audio and video streams to the terminal device for display through a network. The terminal device only needs to have a basic streaming media playback capability and a capability to obtain operation instructions of a gamer and transmit the operation instructions to the server.

FIG. 1 is a schematic diagram of an application mode of a dialog processing method for a virtual scene according to an illustrative aspect of this application. The method is applied to a terminal device 400 and a server 200. The server 200 communicates with the terminal device 400 through a network 300.

For example, the virtual scene is a virtual scene of a game, a database 500 is a game database, and a user is a plot editor (for example, a planner or a scriptwriter) of the game. The following is described in combination with the foregoing example.

The plot editor inputs an initial input statement into the terminal device 400, and the terminal device 400 transmits the initial input statement to the server 200 through the network 300. The server 200 invokes, based on the input statement, field dialog models corresponding to a plurality of virtual objects to generate a large quantity of output statements, invokes a general dialog model to obtain a quality parameter of each output statement, selects a dialog statement from the output statements based on the quality parameter, and iteratively performs the foregoing processing, to obtain a dialog including dialog statements of a plurality of rounds. The dialog is transmitted to the database 500 for storage, and the dialog in the database 500 may be used as a plot of the game. Alternatively, the generated dialog is transmitted to the terminal device 400 for the plot editor to perform screening and modification, and a modified dialog is transmitted to the database 500 for storage, which improves efficiency of generating a dialog of the virtual scene, and reduces time costs and human costs that are required for a continuation of a virtual scene plot.

In some aspects, the server 200 may be an independent physical server, or may be a server cluster including a plurality of physical servers or a distributed system. In other words, the server 200 may be implemented as a plurality of servers. For example, the server 200 may be implemented as a plurality of servers such as a training server (configured to train the field dialog model and the general dialog model), a dialog generation server (storing the field dialog model, and configured to generate output statements corresponding to different virtual objects), and a quality detection server (storing the general dialog model, and configured to detect quality of the output statement).

This aspect of this application may be implemented by using a blockchain technology. Queuing information in this aspect of this application may be used as a detection result, the detection result is uploaded to a blockchain for storage, and reliability of the detection result is ensured by using a consensus algorithm. A blockchain is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, the information being configured for performing verification on the validity of information of the data block (anti-counterfeiting) and generating a next data block. The blockchain may include a blockchain underlying platform, a platform product service layer, and an application service layer.

For example, the server in this aspect of this application may be further a cloud server for providing basic cloud computing services such as a cloud service, a cloud database, cloud computing, a cloud function, cloud storage, a network service, cloud communication, a middleware service, a domain name service, a security service, a CDN, and a big data and artificial intelligence platform. The terminal device may be a smartphone, a tablet computer, a notebook computer, a desktop computer, a smart speaker, a smartwatch, or the like, but is not limited thereto. The terminal device and the server may be directly or indirectly connected in a wired or wireless communication manner. This is not limited in this aspect of this application.

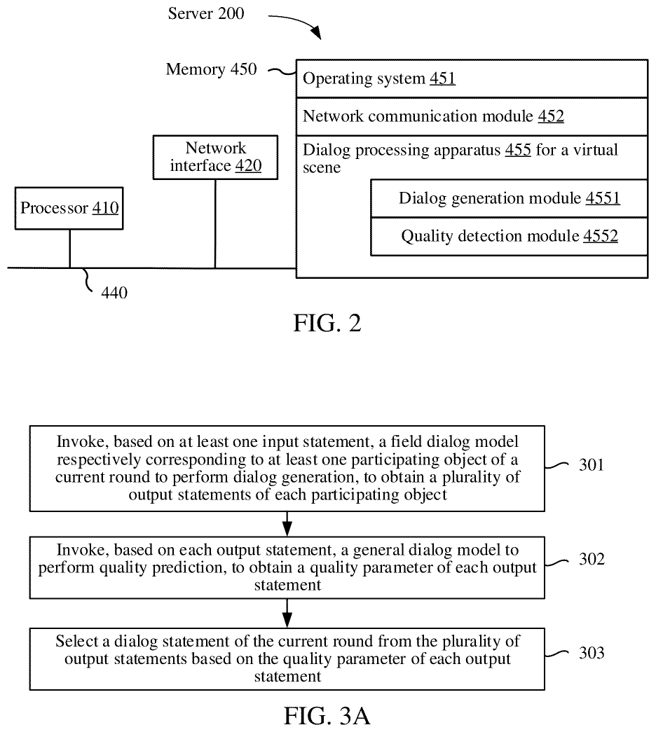

FIG. 2 is a schematic diagram of a structure of a server 200 according to an aspect of this application. The server 200 shown in FIG. 2 includes: at least one processor 410, a memory 450, and at least one network interface 420. Components in the server 200 are coupled together by using a bus system 440. It may be understood that, the bus system 440 is configured to implement connection and communication between the components. In addition to a data bus, the bus system 440 further includes a power bus, a control bus, and a state signal bus. However, for clear description, all types of buses in FIG. 2 are marked as the bus system 440.

The processor 410 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The memory 450 may be a removable memory, a non-removable memory, or a combination thereof. Exemplary hardware devices include a solid-state memory, a hard disk drive, an optical disc driver, and the like. The memory 450, in some aspects, includes one or more storage devices physically away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this aspect of this application is to include any other suitable type of memories.

In some aspects, the memory 450 may store data to support various operations. Examples of the data include a program, a module, and a data structure, or a subset or a superset thereof, which are described below by using examples.

An operating system 451 includes a system program configured to process various basic system services and perform a hardware-related task, such as a framework layer, a core library layer, or a driver layer, and is configured to implement various basic services and process a hardware-based task.

A network communication module 452 is configured to reach another electronic device through one or more (wired or wireless) network interfaces. Exemplary network interfaces include: Bluetooth, wireless compatible authentication (Wi-Fi), a universal serial bus (USB), and the like.

In some aspects, the dialog processing apparatus for a virtual scene provided in this aspect of this application may be implemented by using software. FIG. 2 shows a dialog processing apparatus 455 for a virtual scene stored in a memory 450. The apparatus 455 may be software in a form such as a program and a plug-in, and includes the following software modules: a dialog generation module 4551 and a quality detection module 4552. The modules are logical modules, and may be randomly combined or further divided based on a function to be achieved. The following describes functions of the modules.

The dialog processing method for a virtual scene provided in the aspects of the application is described with reference to an exemplary application and implementation of the terminal device provided in the aspects of the application.

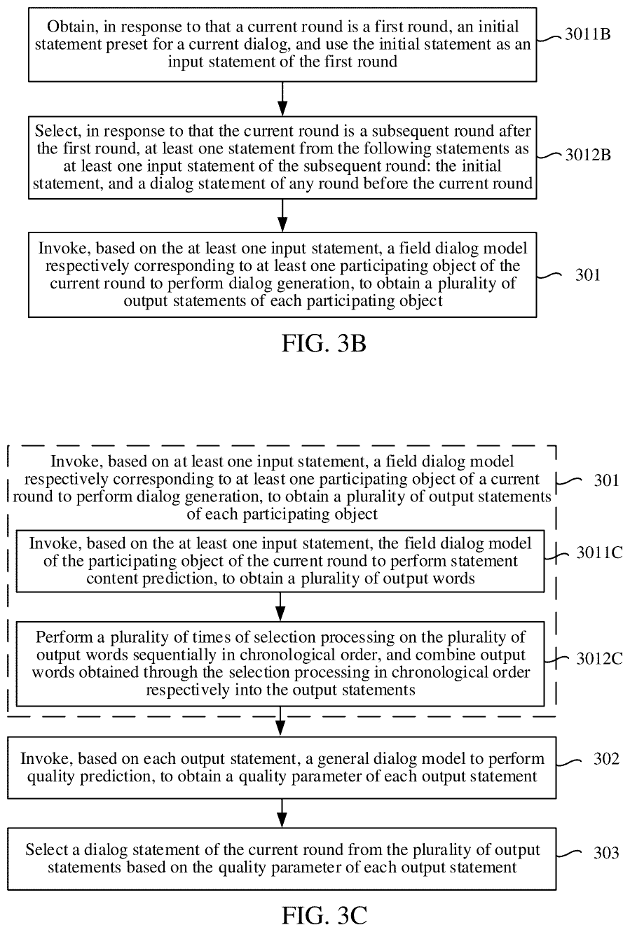

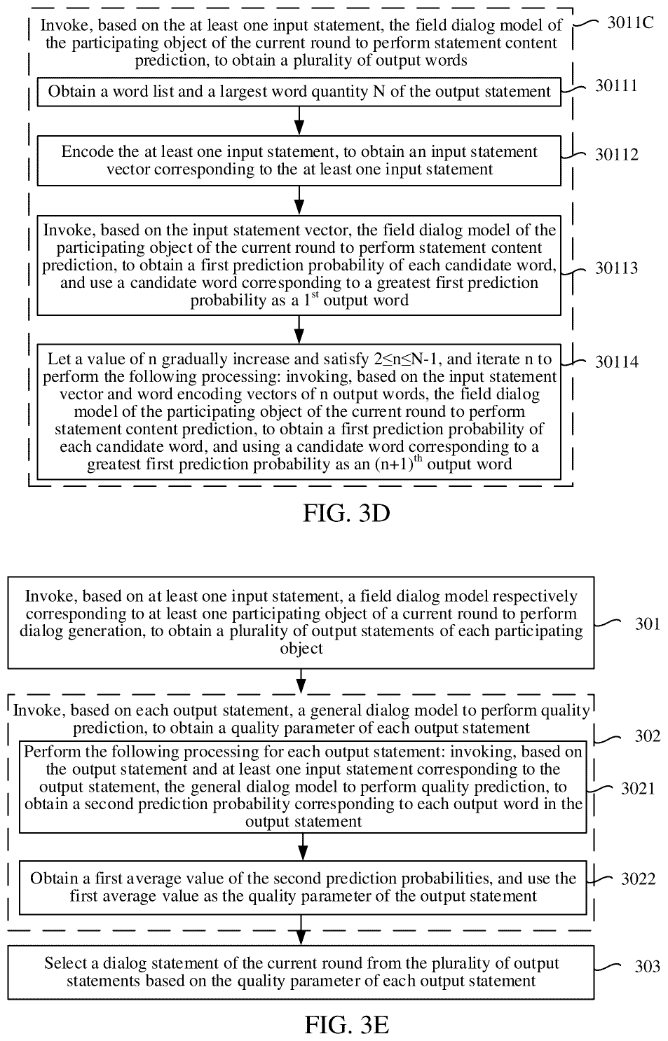

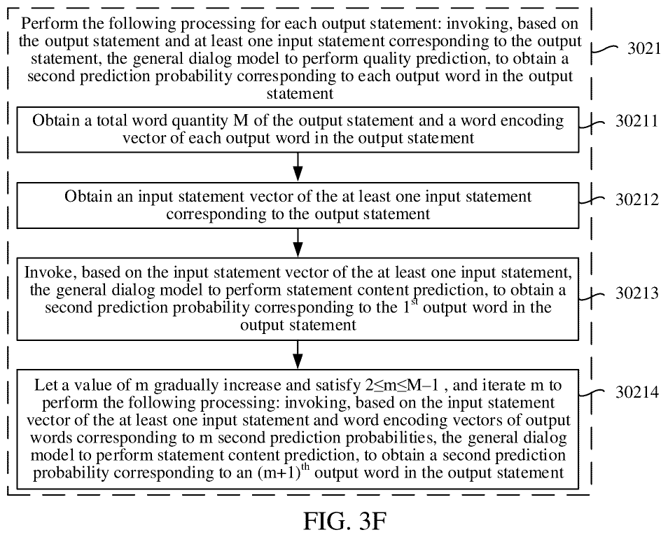

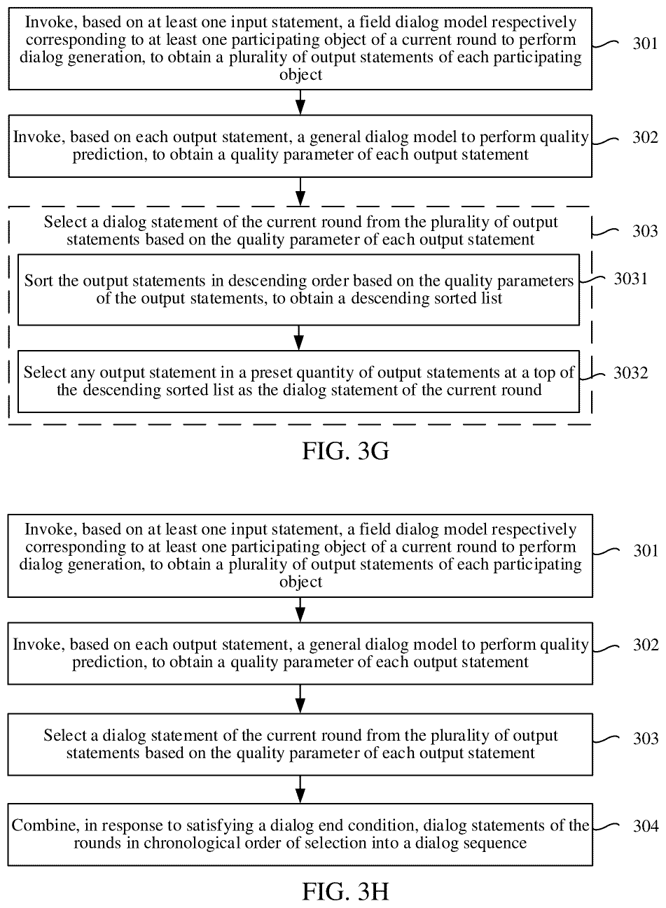

FIG. 3A is a first schematic flowchart of a dialog processing method for a virtual scene according to an aspect of this application. A server is used as an execution body, and description is to be provided with reference to steps shown in FIG. 3A.

Before the steps in FIG. 3A are explained and described, an application scene of the steps in the FIG. 3A is first described. The virtual scene includes a plurality of virtual objects participating in a current dialog, each virtual object corresponds to a field dialog model, the field dialog model is obtained through training based on dialog samples in a particular field, and the current dialog includes to-be-generated dialog statements of a plurality of rounds.

For example, the particular field is a field with a specified language style, for example, an Internet slang, or an ancient style (for example, martial arts novel style) slang. A dialog includes dialog statements of a plurality of rounds, and there are at least two virtual objects speaking in the dialog. For example, a speaking object includes a virtual object A and a virtual object B. The two virtual objects speak sequentially. A name of the virtual object A, a name of the virtual object B, and a dialog statement corresponding to each virtual object form a dialog.

For example, the field dialog model and a general dialog model in the following are obtained through training based on a same to-be-trained model. The to-be-trained model may be a neural network model in each form, for example, a general or generative pre-training (GPT) model. The GPT model is a generative model based on an information transformer, and is generally configured to generate text content. A data set for training the general dialog model may be a general dialog data set (for example, Wudao Corpus-Dialog).

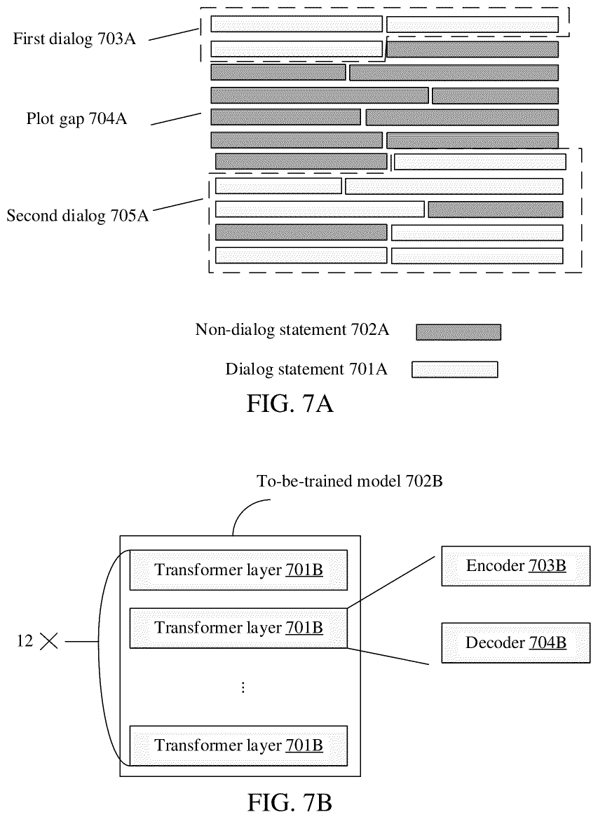

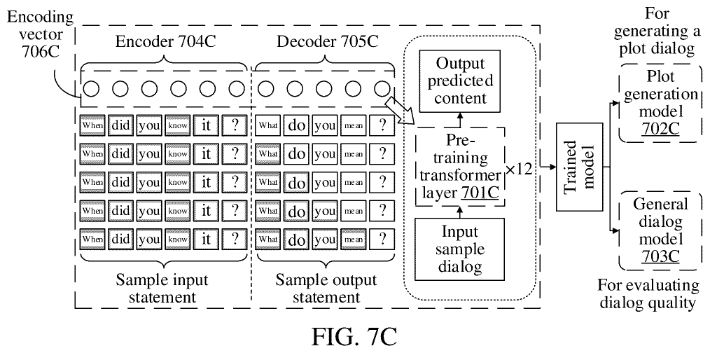

FIG. 7B is a schematic diagram of a first structure of a to-be-trained model according to an illustrative aspect of this application. A to-be-trained model 702B may include 12 transformer layers 701B, and each transformer layer 701B includes an encoder 703B and a decoder 704B. Both the encoder 703B and the decoder 704B can be configured to encode a word, to obtain a corresponding word vector. The transformer layer 701B is further configured to invoke a softmax function to transform the word vector, to obtain a corresponding feature.
Step 301: Invoke, based on at least one input statement, a field dialog model respectively corresponding to at least one participating object of a current round to perform dialog generation, to obtain a plurality of output statements of each participating object.

For example, the at least one participating object is a virtual object other than a speaking object of a previous round in the plurality of virtual objects. The speaking object of the previous round is excluded to prevent the virtual object from having dialogs of a plurality of rounds with the virtual object itself. For example, a participating object of a dialog includes three virtual objects: a virtual object 1, a virtual object 2, and a virtual object 3. If the virtual object 1 speaks in a previous round, a participating object of a current round is the virtual object 2 and the virtual object 3.

In some aspects, FIG. 3B is a second schematic flowchart of a dialog processing method for a virtual scene according to an illustrative aspect of this application. Before step 301 in FIG. 3A, an input statement may be determined through step 3011B and step 3012B in FIG. 3B.
Step 3011B: Obtain, in response to that the current round is a first round, an initial statement preset for the current dialog, and use the initial statement as an input statement of the first round.

For example, the initial statement may be a statement inputted by a game producer or a gamer, or may be preset dialog content that corresponds to any virtual object and is extracted from a corpus. The initial statement may be spoken by any virtual object participating in a dialog. For example, there is a dialog among a virtual object A, a virtual object B, and a virtual object C, and the initial statement is spoken by the virtual object A. Alternatively, the initial statement is unrelated to any virtual object participating in a dialog. For example, the initial statement is an issue in a dialog between virtual objects.
Step 3012B: Select, in response to that the current round is a subsequent round after the first round, at least one statement from the following statements as at least one input statement of the subsequent round: the initial statement, and a dialog statement of any round before the current round.

For example, a dialog includes a plurality of rounds. It is assumed that a current round is an X^{th} round, X is a positive integer greater than 1, a previous round is X−1, and currently there are X−1 dialog statements that have been generated and an initial statement. At least one statement is selected from the X−1 dialog statements that have been generated and the initial statement as an X^{th} input statement.

For example, step 3012B may be implemented in the following manners.
Manner 1: Determine, in response to that a type of a dialog statement of the previous round is a question, that a current dialog scene is a question answering scene, and use at least the dialog statement of the previous round as the input statement.

For example, the type of the statement is determined based on a punctuation (for example, an exclamation mark, a period, or a question mark) or content that is included by the dialog statement. For example, when the dialog statement is ended with a question mark, the type of the dialog statement is a rhetorical question or an interrogative sentence; or when the dialog statement includes a word such as “?” or “whether” that indicates uncertainty, the type of the dialog statement is determined to be a question.

For example, currently there are an initial statement, a statement 1, a statement 2, and a statement 3. A current round is a fourth round, the statement 3 of a previous round is an interrogative sentence, and at least the statement 3 is used as an input statement of the fourth round.
Manner 2: Determine, in response to that the type of the dialog statement of the previous round is not a question, that the current dialog scene is a chat scene, and select at least one statement from a dialog statement of any round before the current round and the initial statement as the input statement.

For example, a current dialog includes: an initial statement, a statement 1, a statement 2, and a statement 3. A current round is a fourth round, the statement 3 of a previous round is not an interrogative sentence, and at least one of the initial statement and the statements 1 to 3 is selected as an input statement.

In this aspect of this application, by determining the input statement of the current round in a plurality of different manners, there is more correlation between generated dialog content and previous dialog content, so that the dialog content is closer to a real dialog, and quality and realism of the dialog content between virtual objects are improved.

In some aspects, before step 301, the at least one participating object of the current round is determined in at least one of the following manners.
Manner 1: Obtain, in a case that the dialog statement of the previous round is an interrogative sentence, at least one piece of role information (for example, a name or a word representing an object) included by the dialog statement of the previous round, and use at least one virtual object corresponding to the at least one piece of role information as the at least one participating object of the current round.

For example, a dialog includes a virtual object A, a virtual object B, and a virtual object C. A dialog statement of a previous round is spoken by the virtual object A, and the dialog statement is an interrogative sentence. A name of the virtual object B that is asked is extracted from the interrogative sentence, and the virtual object B is used as a participating object. Alternatively, a word such as “you” or “you all” that represents an object is extracted from the interrogative sentence, and the virtual object B and the virtual object C that are represented by the word “you all” are used as participating objects.
Manner 2: Use, in a case that the dialog statement of the previous round is a non-interrogative sentence, at least one virtual object other than the speaking object of the previous round in the plurality of virtual objects as the at least one participating object of the current round.

For example, a dialog corresponding to a virtual scene includes five virtual objects, including a virtual object 1, a virtual object 2, a virtual object 3, a virtual object 4, and a virtual object 5. If the virtual object 3 speaks in a previous round, each virtual object other than the virtual object 3 in the five virtual objects is used as a participating object.
Manner 3: Search for, in a dialog round table, at least one participating object preset for the current round.

For example, the dialog round table includes a participating object preset for each dialog round, and participating objects of adjacent rounds in the dialog round table are different. For example, a dialog includes three virtual objects. In the dialog round table, the virtual objects are sorted cyclically in ascending order of serial numbers (1 to 3) of the virtual objects, and sorted order is used as speaking order. In other words, the virtual object 1, the virtual object 2, and the virtual object 3 speak sequentially, and a process of the sequential speaking is performed cyclically. Alternatively, the serial numbers of virtual objects in the dialog round table are randomly sorted, and adjacent serial numbers are different.
Manner 4: Use, in a descending order result of second average values corresponding to the virtual objects, at least one virtual object corresponding to at least one second average value starting from a first place as the at least one participating object of the current round. The second average value corresponding to the virtual object is an average value of quality parameters of output statements corresponding to the virtual object.

For example, in a case that the speaking object of the previous round is excluded, a field dialog model with highest quality of a generated output statement is determined, and a virtual object corresponding to the field dialog model with the highest quality is used as the participating object of the current round. For example, excluding the speaking object of the previous round, and for each remaining virtual object, quality parameters of output statements corresponding to the virtual object are obtained, a second average value of each quality parameter is obtained, and a virtual object corresponding to a highest second average value is used as the participating object of the current round.

In this aspect of this application, the virtual object speaking in the current round is determined in a plurality of different manners, thereby preventing duplication of speaking objects of adjacent rounds from affecting the quality of the dialog. By invoking field dialog models of different virtual objects to perform dialog generation, generated dialog content is richer, efficiency and quality of dialog generation are improved, and realism of the dialog content between virtual objects is improved.

In some aspects, FIG. 3C is a third schematic flowchart of a dialog processing method for a virtual scene according to an aspect of this application. Step 301 in FIG. 3A may be implemented through step 3011C and step 3012C in FIG. 3C, which is specifically described below.
Step 3011C: Invoke, based on the at least one input statement, the field dialog model of the participating object of the current round to perform statement content prediction, to obtain a plurality of output words.

The statement content prediction is performed by predicting a granularity of each word in the output statement. FIG. 3D is a fourth schematic flowchart of a dialog processing method for a virtual scene according to an aspect of this application. Step 3011C in FIG. 3C may be implemented through step 30111 to step 30114 in FIG. 3D, which is specifically described below.
Step 30111: Obtain a word list and a largest word quantity N of the output statement.

For example, N is a positive integer, for example, 128 words. The word list includes a plurality of candidate words and a word encoding vector corresponding to each candidate word. The word list is a list of candidate words that can be used in dialog content obtained in advance. A quantity of candidate words may be massive (for example, 30,000). In a training stage, the candidate word may be extracted from text data for training the field dialog model.
Step 30112: Encode the at least one input statement, to obtain an input statement vector corresponding to the at least one input statement.

For example, the encoding is to transform the input statement from text into data that can be directly read by a computer. Each character of a transformed input statement is represented by data of each dimension in the vector.
Step 30113: Invoke, based on the input statement vector, the field dialog model of the participating object of the current round to perform statement content prediction, to obtain a first prediction probability of each candidate word, and use a candidate word corresponding to a greatest first prediction probability as a 1^{st} output word.

For example, the statement content prediction includes: invoking, based on the input statement vector, the field dialog model of the participating object of the current round to predict the first prediction probability of each candidate word in the word list, the first prediction probability representing a probability of the candidate word occurring in the output statement. A greatest first prediction probability represents a greatest possibility of the candidate word occurring in the output statement, and the candidate word is used as a first output word in the output statement.

For example, statement content prediction of the first round may be implemented by using the following formula (1):

$${y}_{nxet} = tokenizer\_decode ( arg max ( softmax ( gpt ( x , {y}_{pre} ) ) ) ) \qquad ( 1 )$$

In the first round, x is the input statement, and yₚᵣₑ=0, which represents that there is no output word generated currently. yₙₓₑₜ represents an output word obtained through prediction in the first round. gpt(x,yₚᵣₑ) represents that the field dialog model encodes the input statement, to obtain the input statement vector, and a probability feature is obtained through prediction based on the input statement vector. A softmax function normalizes the probability feature to obtain the first prediction probability (a value range is [0, 1]). An argmax function is configured for obtaining an index value corresponding to the greatest first prediction probability in the word list. A tokenizer_decode function is configured for obtaining text of a corresponding candidate word in the word list based on the index value of the greatest first prediction probability, to obtain a candidate word yₙₓₑₜ corresponding to the greatest first prediction probability.
Step 30114: let a value of n gradually increase and satisfy 2≤n≤N−1, and iterate n to perform the following processing: invoking, based on the input statement vector and word encoding vectors of n output words, the field dialog model of the participating object of the current round to perform statement content prediction, to obtain a first prediction probability of each candidate word, and using a candidate word corresponding to a greatest first prediction probability as an (n+1)^{th} output word.

For example, in the subsequent round, yₚᵣₑ in the foregoing formula (1) is configured for representing an output word that has been obtained through prediction currently. For example, the current round is a 3^{rd} round. Before this, if two output words have been obtained through prediction, yₚᵣₑ in the formula (1) represents that two output words have been obtained through prediction, and an output word of the 3^{rd} round is obtained through prediction based on the two output words and the input statement.

Refer to FIG. 3C continuously. Step 3012C: Perform a plurality of times of selection processing on the plurality of output words sequentially in chronological order, and combine output words obtained through selection processing in chronological order respectively into the output statements.

A selection quantity of a first time of selection processing is one, and selection quantities of the plurality of times of selection processing increase sequentially.

For example, one output word is obtained through a first selection, and the output word may be used as one output statement. A first output word and a second output word are obtained through a second selection, and the two output words are combined into one output statement. By analogy, output words obtained through each time of selection may be combined into one output statement, thereby obtaining a plurality of output statements.

In this aspect of this application, a plurality of output statements are generated by using a field dialog model, thereby improving richness of a dialog and improving quality of final generated dialog content.

Refer to FIG. 3A continuously. Step 302: Invoke, based on each output statement, a general dialog model to perform quality prediction, to obtain a quality parameter of each output statement.

The general dialog model is obtained through training based on dialog samples in a general field. For example, the quality parameter is configured for representing fluency of the output statement. Fluency means that text is fluent without a grammatical error. The higher the quality parameter, the higher the fluency of the output statement and the closer the output statement is to a real language expression. A structure of the general dialog model is the same as that of the field dialog model, and the two models are obtained through training by using different samples. Training the model based on the dialog samples in the general field can enable the model to have a function of generating general dialog content and then evaluate the quality parameter of the fluency of the output statement by using the general dialog model.

FIG. 3E is a fifth schematic flowchart of a dialog processing method for a virtual scene according to an aspect of this application. Step 302 in FIG. 3A may be implemented through step 3021 and step 3022 in FIG. 3E, which is specifically described below.
Step 3021: Perform the following processing for each output statement: invoking, based on the output statement and at least one input statement corresponding to the output statement, the general dialog model to perform quality prediction, to obtain a second prediction probability corresponding to each output word in the output statement.

For example, a manner of determining the output statement has been explained above and is not described herein again. A process of predicting the second prediction probability corresponding to the output word by using the general dialog model is predicting a probability of the output word occurring in the statement based on the general dialog model. The higher the probability of the output word occurring in the statement, the more consistent the output word is with a real language expression, and the higher fluency of the output statement.

FIG. 3F is a sixth schematic flowchart of a dialog processing method for a virtual scene according to an aspect of this application. Step 3021 in FIG. 3E may be implemented through step 30211 to step 30214 in FIG. 3F, which is specifically described below.
Step 30211: Obtain a total word quantity M of the output statement and a word encoding vector of each output word in the output statement.

For example, M is a positive integer, and the word encoding vector of each output word in the output statement may be directly obtained from the word list. Reference may be made to step 30111 above, and details are not described herein again.
Step 30212: Obtain an input statement vector of the at least one input statement corresponding to the output statement.

For example, for performing of step 30212, reference may be made to step 30112 above, and details are not described herein again.
Step 30213: Invoke, based on the input statement vector of the at least one input statement, the general dialog model to perform statement content prediction, to obtain a second prediction probability corresponding to a 1^{st} output word in the output statement.

For example, the invoking the general dialog model to perform statement content prediction may be implemented in the following manner: invoking the general dialog model based on the at least one input statement, and performing probability prediction for the 1^{st} output word, to obtain the second prediction probability corresponding to the 1^{st} output word.
Step 30214: Let a value of m gradually increase and satisfy 2≤m≤M−1, and iterate m to perform the following processing: invoking, based on the input statement vector of the at least one input statement and word encoding vectors of output words corresponding to m second prediction probabilities, the general dialog model to perform statement content prediction, to obtain a second prediction probability corresponding to an (m+1)^{th} output word in the output statement.

For example, a principle of step 30214 is the same as that of step 30114, and details are not described herein again.

Refer to FIG. 3E continuously. Step 3022: Obtain a first average value of second prediction probabilities, and use the first average value as the quality parameter of the output statement.

For example, it is assumed that there are 10 words in the output statement, a sum of second prediction probabilities of the words is obtained, and a result of dividing the sum by 10 is used as the quality parameter of the output statement.

In this aspect of this application, by evaluating a quality parameter of an output statement and quantifying fluency of the output statement, quality of dialog content can be improved, so that the dialog content conforms to a particular field corresponding to a virtual scene, the dialog content is more realistic, realism of the virtual scene is improved, and labor cost of editing a plot of the virtual scene is reduced.

Refer to FIG. 3A continuously. Step 303: Select a dialog statement of the current round from the plurality of output statements based on the quality parameter of each output statement.

For example, a selection manner includes any one of the following: selecting an output statement with a highest quality parameter as the dialog statement of the current round; and randomly selecting an output statement in at least one output statement at a top of a descending sorted list of quality parameters as the dialog statement of the current round.

FIG. 3G is a seventh schematic flowchart of a dialog processing method for a virtual scene according to an aspect of this application. Step 303 in FIG. 3A may be implemented through step 3031 and step 3032 in FIG. 3G, which is specifically described below.
Step 3031: Sort the output statements in descending order based on the quality parameters of the output statements, to obtain a descending sorted list.

For example, the quality parameter represents fluency of the output statement. The higher the quality parameter, the higher the fluency of the output statement. If the output statements are sorted in descending order based on the quality parameters, a quality parameter of an output statement that is sorted earlier in the descending sorted list is higher, and fluency of the output statement is higher.
Step 3032: Select any output statement in a preset quantity of output statements at a top of the descending sorted list as the dialog statement of the current round.

For example, the higher an order in the descending sorted list, the higher the quality parameter. For example, the preset quantity may be three, and any one in three front output statements at the top of the descending sorted list is selected as the dialog statement of the current round.

FIG. 3H is an eighth schematic flowchart of a dialog processing method for a virtual scene according to an aspect of this application. After step 303 in FIG. 3A, step 304 in FIG. 3H is performed. Step 304: Combine, in response to satisfying a dialog end condition, dialog statements of rounds in chronological order of selection into a dialog sequence.

For example, the dialog sequence may be used as a dialog, including dialog statements of a plurality of rounds and a speaking virtual object corresponding to the dialog statement of each round. Alternatively, the initial statement and the dialog sequence are combined together, and are used as complete content of a dialog. A plurality of dialogs are obtained, and dialog content may be used as a game plot.

For example, the dialog sequence is also a dialog, including a dialog statement of each round and a virtual object corresponding to each dialog statement. The dialog end condition includes at least one of the following:
1. A quantity of generated dialog statements reaches a statement quantity threshold. For example, it is assumed that the statement quantity threshold is 10, and if the quantity of generated dialog statements is 10, the dialog end condition is satisfied.
2. A total dialog content word quantity is greater than a dialog word quantity threshold, where the total dialog content word quantity is a sum of the following parameters: a word quantity of the generated dialog statements, and a word quantity of the input statement of the first round.

For example, the dialog word quantity threshold may be 1000, and when a total word quantity of the initial statement (the input statement of the first round) and the generated dialog statements is greater than or equal to 1000, the dialog end condition is satisfied.
3. Field dialog models corresponding to participating objects respectively output at least one dialog statement. For example, a dialog corresponds to five virtual objects, and in currently generated dialog statements, if each virtual object corresponds to at least one dialog statement, each virtual object has spoken, and the dialog end condition is satisfied.

In this aspect of this application, output statements corresponding to different virtual objects are generated through field dialog models respectively corresponding to the different virtual objects, which improves realism of a dialog between virtual objects. Based on an initial statement, a continuation of a dialog in a particular field is available, and a generated dialog can be used as plot content of a virtual scene of a game, which reduces time and cost required for editing a game plot. A quality parameter of the output statement is evaluated based on a general dialog model, and the output statement is selected based on the quality parameter, which improves quality of dialog content.

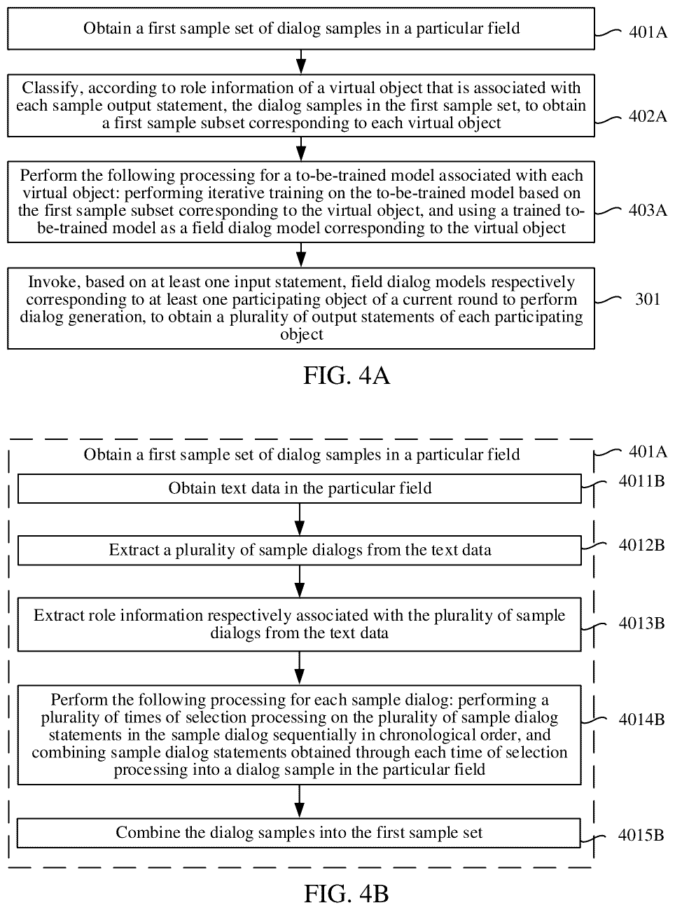

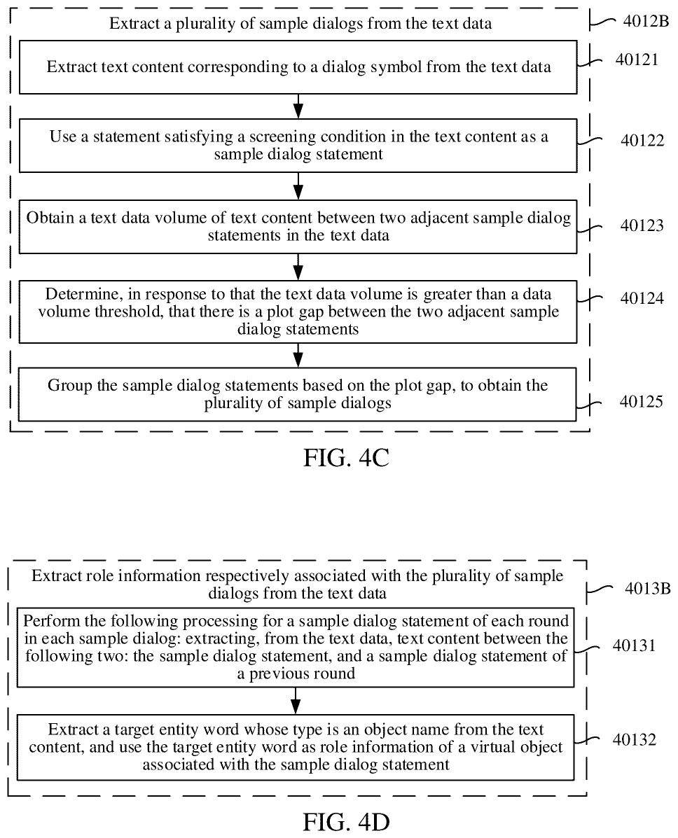

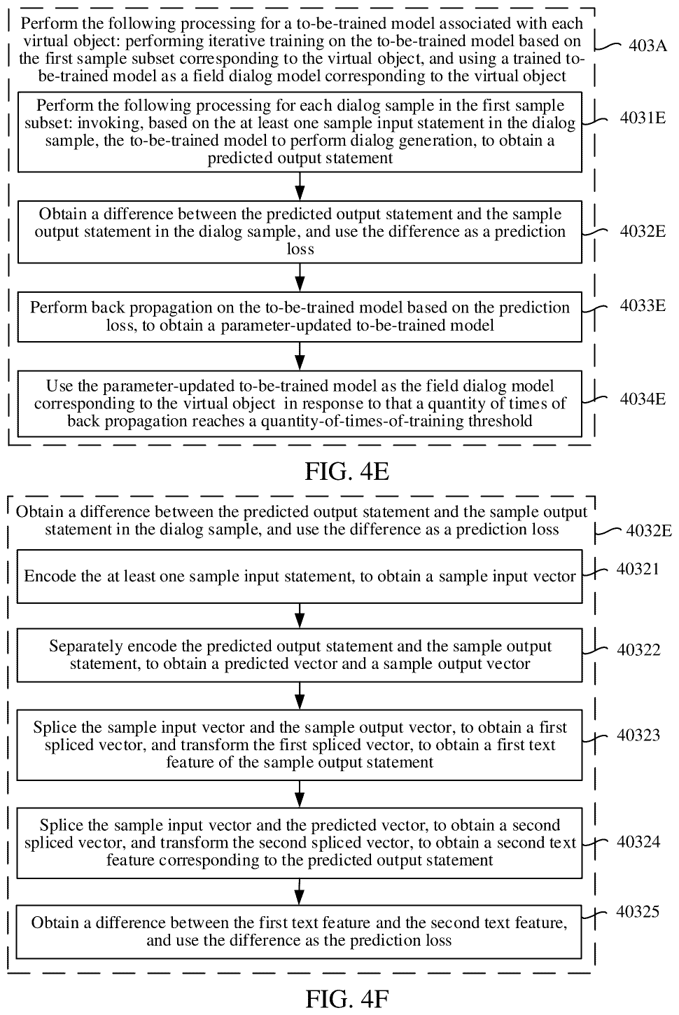

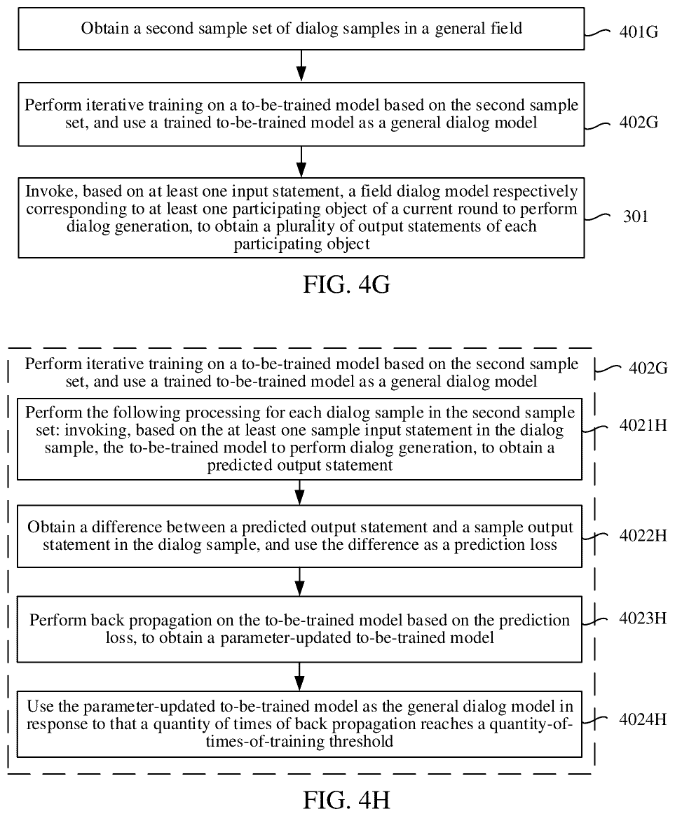

In some aspects, FIG. 4A is a ninth schematic flowchart of a dialog processing method for a virtual scene according to an aspect of this application. Before step 301, a field dialog model may be trained through step 401A to step 403A in FIG. 4A, which is specifically described below.
Step 401A: Obtain a first sample set of the dialog samples in the particular field.

Herein each dialog sample includes at least one sample input statement, a sample output statement for replying to the at least one sample input statement, and role information of a virtual object that outputs the sample output statement.

For example, the role information of the virtual object that outputs the sample output statement is role information of a virtual object that speaks or represents the sample output statement in the virtual scene. For example, the dialog sample is a dialog, and the dialog includes a statement 1, a statement 2, and a statement 3. The statement 1 and the statement 2 are sample input statements, and the statement 3 is a sample output statement. If the statement 1 is spoken by Role A, the statement 2 is spoken by Role B, and the statement 3 is spoken by Role A, the sample output statement is spoken by Role A.

In some aspects, FIG. 4B is a tenth schematic flowchart of a dialog processing method for a virtual scene according to an aspect of this application. Step 401A may be implemented through step 4011B to step 4015B in FIG. 4B, which is specifically described below.
Step 4011B: Obtain text data in the particular field.

For example, the text data may be obtained from the Internet through crawling by a crawler, and the particular field may be a field of a martial arts novel, which is explained and described below with reference to an example. For example, a large amount of text data of the martial arts novel is crawled from the Internet.
Step 4012B: Extract a plurality of sample dialogs from the text data.

For example, each sample dialog includes sample dialog statements of a plurality of rounds. In some aspects, FIG. 4C is an eleventh schematic flowchart of a dialog processing method for a virtual scene according to an aspect of this application. Step 4012B may be implemented through step 40121 to step 40125, which is specifically described below.
Step 40121: Extract text content corresponding to a dialog symbol from the text data.

For example, the dialog symbol includes at least one of the following: a double quote, a single quote, and a colon.

For example, the text content is represented by an ellipsis, and the text content is a script in the following format.
Role A: . . .
Role B: . . .

Text content corresponding to a colon is a statement after the colon.

For another example, the text content is a novel in the following format. Role C said: “ . . . , and Role B had mentioned that ‘ . . . ’”. Content in a quotation mark is text content corresponding to the quotation mark.
Step 40122: Use a statement satisfying a screening condition in the text content as a sample dialog statement.

The screening condition includes at least one of the following: a quantity of times of occurrence of the text content is less than a quantity-of-times threshold, and a word quantity of the text content is greater than a word quantity threshold.

For example, in addition to a statement spoken by a role, content included in a quotation mark in text also includes onomatopoeia. The word quantity threshold may be 1 or 2, and the quantity-of-times threshold may be 20 times. Text content with a length less than or equal to 2 words and a quantity of times of occurrence greater than or equal to 20 is deleted. Remaining text content is retained as the sample dialog statement.
Step 40123: Obtain a text data volume of text content between two adjacent sample dialog statements in the text data.

For example, the text data volume is represented in at least one of the following manners: a text word quantity, a row quantity corresponding to text, and a sentence quantity corresponding to the text.
Step 40124: Determine, in response to that the text data volume is greater than a data volume threshold, that there is a plot gap between the two adjacent sample dialog statements.

For example, the data volume threshold may be set based on a representation manner of the text data volume. For example, if the text data volume is represented through the text word quantity, the data volume threshold may be a word quantity threshold, for example, 1000 words. If the text data volume is represented through the row quantity, the data volume threshold may be a row quantity threshold, for example, 10 rows. If the text data volume is represented through the sentence quantity corresponding to the text, the data volume threshold may be a sentence quantity threshold, for example, 10 sentences.
Step 40125: Group the sample dialog statements based on each plot gap, to obtain the plurality of sample dialogs.

For example, each sample dialog includes at least two sample dialog statements. The plurality of sample dialog statements are grouped based on the plot gap. FIG. 7A is a schematic diagram of text according to an aspect of this application. Each box in FIG. 7A represents a statement, and a plurality of statements form a segment of text. If a data volume is represented through a sentence quantity corresponding to the text, a data volume threshold may be a sentence quantity threshold, for example, 10 sentences. A dialog statement 701A is represented by a blank box, a non-dialog statement 702A is represented by a shaded box, and there are 10 non-dialog statements 702A in a plot gap 704A. The text is grouped based on the plot gap 704A, to obtain a first dialog 703A and a second dialog 705A. There are non-dialog statements between some dialog statements in the second dialog 705A, and a data volume corresponding to the non-dialog statements is less than the data volume threshold.

In this aspect of this application, by screening text content, a plurality of dialogs are extracted from text data in a particular field, and invalid content is deleted through screening, which can improve effect of training a dialog model and improve accuracy of the dialog model in predicting an output statement, so that the output statement is closer to a real dialog.

Refer to FIG. 4B continuously. Step 4013B: Extract role information respectively associated with the plurality of sample dialogs from the text data.

For example, sample dialog statements of adjacent rounds are respectively outputted by different virtual objects. Outputting refers to speaking or expressing. The sample dialog statements of adjacent rounds in the sample dialog respectively correspond to different virtual objects, which can avoid that in a dialog obtained through prediction of a dialog model, a virtual object speaks continuously in adjacent rounds, and can improve realism of dialog content.

In some aspects, FIG. 4D is a twelfth schematic flowchart of a dialog processing method for a virtual scene according to an aspect of this application. Step 4013B in FIG. 4B may be implemented through step 40131 and step 40132 in FIG. 4D, which is specifically described below.
Step 40131: Perform the following processing for a sample dialog statement of each round in each sample dialog: extracting, from the text data, text content between the following two: the sample dialog statement, and a sample dialog statement of a previous round.

For example, the text content between the sample dialog statement and the sample dialog statement of the previous round includes information of a virtual object corresponding to the sample dialog statement. For example, the text content is shown below.
Role A said: “Today is Monday”. Role B said: “How was your weekend?”.

The sample dialog statement is “How was your weekend?”, and the text content between the sample dialog statement and the sample dialog statement of the previous round is “Role B said”.
Step 40132: Extract a target entity word whose type is an object name from the text content, and use the target entity word as role information of a virtual object associated with the sample dialog statement.

For example, description is continued based on the foregoing examples. A target entity word “Role B” whose type is the object name may be extracted from the text content, and then Role B is used as role information of the sample dialog statement “How was your weekend?” of a second round.

Refer to FIG. 4B continuously. Step 4014B: Perform the following processing for each sample dialog: performing a plurality of times of selection processing on the plurality of sample dialog statements in the sample dialog sequentially in chronological order, and combining sample dialog statements obtained through each time of selection processing into a dialog sample in the particular field.

A selection quantity of a first time of selection processing is two, and selection quantities of the plurality of times of selection processing increase sequentially. For example, for the plurality of sample dialog statements in the sample dialog, two are selected for the first time, and three are selected for a second time, and so on.

In each dialog sample, a last sample dialog statement is a sample output statement, and a sample dialog statement other than the last sample dialog statement is a sample input statement. For example, for a statement 1 and a statement 2 that are selected for the first time, the statement 1 is used as a sample input statement, and the statement 2 is used as a sample output statement; and for the statement 1 to a statement 3 that are selected for the second time, the statement 1 and the statement 2 are used as sample input statements, and the statement 3 is used as a sample output statement, and so on.

For example, it is assumed that a dialog includes Y dialog statements, Y is a positive integer, and the dialog statements are respectively a statement 1 to a statement Y in chronological order. In a first time of selection processing, the statement 1 and a statement 2 are combined into a dialog sample, where the statement 1 is a sample input statement, and the statement 2 is a sample output statement. In an i^{th} time of selection processing, the statement 1 to a statement i (less than or equal to Y−1) are selected, the statement 1 to a statement i−1 are used as sample input statements, and the statement i is used as a sample output statement.
Step 4015B: Combine the dialog samples into the first sample set.

For example, description is continued based on the foregoing examples. Y−1 dialog samples may be obtained based on a dialog, and the Y−1 dialog samples are added into the first sample set. The processing above is performed for each dialog, to obtain dialog samples corresponding to different dialogs, and the dialog samples are combined into the first sample set.

In this aspect of this application, a dialog including dialog statements of a plurality of rounds is multiplexed, to generate a plurality of sample dialogs, which improves efficiency of obtaining a sample and reduces a calculation amount required for obtaining the sample.

Refer to FIG. 4A continuously. Step 402A: Classify, according to the role information of the virtual object that outputs the sample output statement, the dialog samples in the first sample set, to obtain a first sample subset corresponding to each virtual object.

For example, each sample output statement in the first sample subset corresponds to a same virtual object. By classifying dialog samples, field dialog models corresponding to different virtual objects may be trained based on language styles of the different virtual objects, so that finally generated dialog content is more vivid.
Step 403A: Perform the following processing for a to-be-trained model associated with each virtual object: performing iterative training on the to-be-trained model based on the first sample subset corresponding to the virtual object, and using a trained to-be-trained model as a field dialog model corresponding to the virtual object.

For example, a quantity of times of iterative training may be a quantity-of-times-of-training threshold (for example, 10 times).

Alternatively, whether to stop training is determined based on training effect. When a similarity between an output statement outputted by the to-be-trained model and the sample output statement in the sample dialog is greater than or equal to a similarity threshold, training is stopped. For example, feature extraction is performed on the output statement outputted by the to-be-trained model to obtain a predicted statement feature, feature extraction is performed on the sample output statement in the sample dialog to obtain a sample statement feature, the statement features are represented through vectors, and a cosine similarity between the predicted statement feature and the sample statement feature is obtained.

In some aspects, FIG. 4E is a thirteenth schematic flowchart of a dialog processing method for a virtual scene according to an aspect of this application. Step 403A may be implemented through step 4031E to step 4034E in FIG. 4E, which is specifically described below.
Step 4031E: Perform the following processing for each dialog sample in the first sample subset: invoking, based on the at least one sample input statement in the dialog sample, the to-be-trained model to perform dialog generation, to obtain a predicted output statement.

For example, for a specific principle of dialog generation, reference may be made to step 301 above, and details are not described herein again.
Step 4032E: Obtain a difference between the predicted output statement and the sample output statement in the dialog sample, and use the difference as a prediction loss.

For example, the difference between the predicted output statement and the sample output statement is represented through a difference between text features of the statements, which is specifically described below. FIG. 4F is a fourteenth schematic flowchart of a dialog processing method for a virtual scene according to an aspect of this application. Step 4032E may be implemented through the following step 40321 to step 40325, which is specifically described below.
Step 40321: Encode the at least one sample input statement, to obtain a sample input vector.
Step 40322: Separately encode the predicted output statement and the sample output statement, to obtain a predicted vector and a sample output vector.

For example, for a principle of encoding in step 40321 and step 40322, reference may be made to step 30112 above, and details are not described herein again.
Step 40323: Splice the sample input vector and the sample output vector, to obtain a first spliced vector, and transform the first spliced vector, to obtain a first text feature of the sample output statement.

For example, a splicing process is as follows: the sample input vector is at the front, the sample output vector is at the back, and the two are used as a complete vector to obtain the first spliced vector. For example, the sample input vector is a 20-dimensional vector S1, the sample output vector is a 10-dimensional vector S2, the sample input vector and the sample output vector are spliced to obtain a first spliced vector P1, and P1=(S1, S2). A dimension of the first spliced vector P1 is 30, first 20 dimensions are formed by the vector S1, and last 10 dimensions are formed by the vector S2.

For example, transformation is implemented in the following manner: invoking a transformer layer in the to-be-trained model to perform transformation of a plurality of levels on the first spliced vector, and the first text feature is obtained through prediction. Refer to FIG. 7B continuously. Each transformer layer 701B in a to-be-trained model 702B is invoked to perform transformation of a plurality of levels on the first spliced vector, an output of an upper transformer layer 701B is used as an input of a lower transformer layer 701B, and the first text feature is obtained through prediction.
Step 40324: Splice the sample input vector and the predicted vector, to obtain a second spliced vector, and transform the second spliced vector, to obtain a second text feature corresponding to the predicted output statement.

For example, principles of splicing and transformation are shown in step 40323, and details are not described herein again.
Step 40325: Obtain a difference between the first text feature and the second text feature, and use the difference as the prediction loss.

For example, the first text feature and the second text feature may be represented as probability distributions, and the probability distributions corresponding to the two are subtracted to obtain the difference between the first text feature and the second text feature, and the difference is used as the prediction loss. The prediction loss represents a difference between the predicted output statement obtained through prediction and the sample output statement actually corresponding to the sample input statement.

Refer to FIG. 4E continuously. Step 4033E: Perform back propagation on the to-be-trained model based on the prediction loss, to obtain a parameter-updated to-be-trained model.

For example, back propagation may be implemented in the following manner: performing back propagation on the to-be-trained model layer by layer based on the prediction loss to calculate a gradient of parameters (a gradient descent method may be configured for obtaining the parameter. The gradient descent method includes: searching for a minimum value of a loss function along a direction of a gradient descent of the loss function to obtain an optimal parameter), and calculating an updated parameter of each layer of the to-be-trained model based on the gradient. An updated to-be-trained model may be obtained by using the updated parameter to replace a corresponding parameter in the to-be-trained model.
Step 4034E: Use the parameter-updated to-be-trained model as the field dialog model corresponding to the virtual object in response to that a quantity of times of back propagation reaches a quantity-of-times-of-training threshold.

In some aspects, the quantity-of-times-of-training threshold is, for example, 50 times. Alternatively, when the difference between the predicted output statement and the sample output statement is less than a preset value, training is stopped, and the parameter-updated to-be-trained model is used as the field dialog model corresponding to the virtual object.

In some aspects, FIG. 4G is a fifteenth schematic flowchart of a dialog processing method for a virtual scene according to an aspect of this application. Before step 301 in FIG. 3A, a general dialog model may be trained through step 401G to step 403G in FIG. 4G, which is specifically described below.
Step 401G: Obtain a second sample set of dialog samples in a general field.

Herein each dialog sample includes at least one sample input statement, and a sample output statement for replying to the at least one sample input statement.
Step 402G: Perform iterative training on a to-be-trained model based on the second sample set, and use a trained to-be-trained model as a general dialog model.

In some aspects, FIG. 4H is a sixteenth schematic flowchart of a dialog processing method for a virtual scene according to an aspect of this application. Step 402G may be implemented through step 4021H to step 4024H in FIG. 4H, which is specifically described below.
Step 4021H: Perform the following processing for each dialog sample in the second sample set: invoking, based on the at least one sample input statement in the dialog sample, the to-be-trained model to perform dialog generation, to obtain a predicted output statement.
Step 4022H: Obtain a difference between a predicted output statement and a sample output statement in the dialog sample, and use the difference as a prediction loss.
Step 4023H: Perform back propagation on the to-be-trained model based on the prediction loss, to obtain a parameter-updated to-be-trained model.
Step 4024H: Use the parameter-updated to-be-trained model as the general dialog model in response to that a quantity of times of back propagation reaches a quantity-of-times-of-training threshold.

For example, for a principle of step 4021H to step 4024H, reference may be made to step 4031E to step 4034E, and details are not described herein again.

In this aspect of this application, by training a general dialog model and a field dialog model based on a same to-be-trained model, accuracy of evaluating a quality parameter of an output statement is improved, so that a dialog statement with higher fluency can be obtained, and efficiency and quality of generating a dialog of virtual objects are improved.

In this aspect of this application, an output dialog is generated by invoking a field dialog model in a particular field based on an input statement, which improves efficiency of generating a dialog of virtual objects. By invoking a general dialog model to evaluate quality of the output dialog, quality of generated dialog content is improved. A dialog including dialog statements of a plurality of rounds can be generated based on an initial statement, which improves efficiency and quality of generating the dialog of the virtual objects. A dialog plot that conforms to a game procedure can be generated based on game-related logic, which assists game plot creation, and satisfies a creation requirement for a richer game type.

The following describes an exemplary application of the dialog processing method for a virtual scene according to this aspect of this application in an actual application scenario.

In a plot-based virtual scene of a game, a large amount of dialog information of various characters (virtual objects) is often needed to enrich game experience of a player. Generation of plot content requires a lot of manpower and time. Through the dialog processing method for a virtual scene according to this aspect of this application, a plot dialog between different game roles (virtual objects) can be generated based on a game plot by receiving an initial statement. A plot editor may use the generated plot dialog to screen content as dialog content of the game roles. Through the dialog processing method for a virtual scene according to this aspect of this application, a large amount of plot dialog content that conforms to a game scene can be quickly generated.

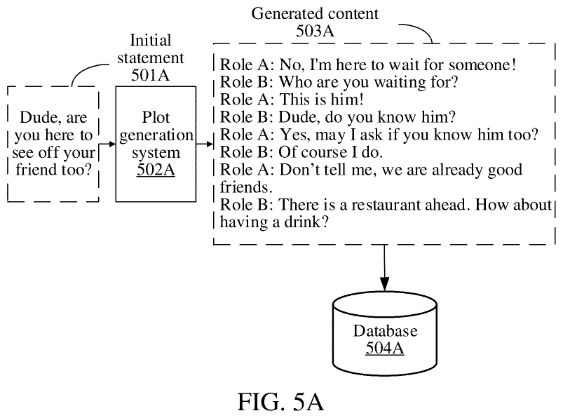

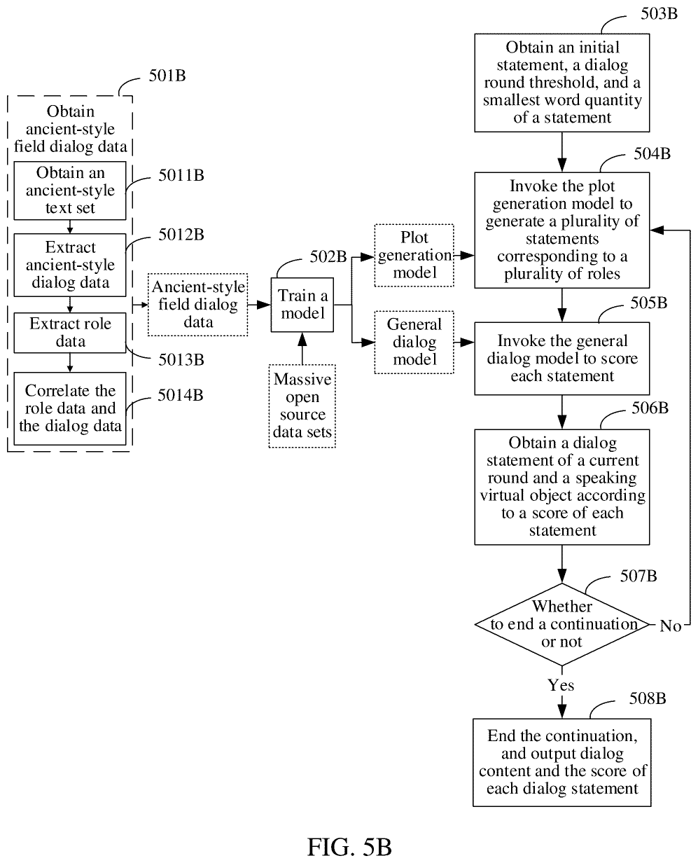

FIG. 5A is a schematic diagram of an application scene of a dialog processing method for a virtual scene according to an aspect of this application. An application of the dialog processing method for a virtual scene according to this aspect of this application is to be explained and described with reference to FIG. 5A. It is assumed that a dialog scene includes Role A and Role B, and an editor inputs an initial statement. The initial statement is content with a martial arts style, and the initial statement is inputted to a plot generation system 502A based on an identity of Role A or Role B. The plot generation system 502A is a system that runs the dialog processing method for a virtual scene according to this aspect of this application. For example, an initial statement 501A “Dude, are you here to see off your friend too?” is inputted into the plot generation system 502A based on the identity of Role B, to obtain the following generated content 503A.
“Role A: No, I'm here to wait for someone!
Role B: Who are you waiting for?
Role A: Him!
Role B: Dude, do you really know him?
Role A: Yes, do you know him too?
Role B: Of course I do.
Role A: Then we are already good friends.
Role B: There is a restaurant ahead. How about having a drink?”

The generated content 503A and the initial statement 501A form a dialog, and the generated content 503A and the initial statement 501A are stored in a database 504A. The database 504A may be a game database, and a large amount of dialog content is stored in the game database and may be configured for producing a game plot. The editor only needs to input the initial statement based on an identity of any role in the dialog, the dialog processing method for a virtual scene according to this aspect of this application is performed, and plot dialog content after the initial statement may be generated. The foregoing generated content is generated in a style of a martial arts novel, and has a martial arts style. The editor may directly adopt the content, or adjust the plot dialog content and then store the plot dialog content in the game database.

In some aspects, a particular field may be a language style field such as an Internet language, an ancient-style novel, an English translation style, or a popular science literature. In this aspect of this application, that the particular field is an ancient-style novel field is used as an example for explanation and description. FIG. 5B is a seventeenth schematic flowchart of a dialog processing method for a virtual scene according to an aspect of this application. A server is used as an execution body, and description is to be provided in combination with steps shown in FIG. 5B.
Step 501B: Obtain ancient-style field dialog data.

For example, the ancient-style field dialog data may be extracted from text such as martial arts novel text, historical novel text, and a classical Chinese document crawled from the Internet.

In this aspect of this application, when implementation of an involved data crawling technical solution, for example, crawling novel text from the Internet in the foregoing aspect of this application is applied to a specific product or technology, relevant data collection, use, and processing processes are to comply with requirements of national laws and regulations, comply with a principle of legality, legitimacy, and necessity, not involve obtaining of a data type prohibited or restricted by the laws and regulations, and not hinder normal operation of a target website.

In some aspects, step 501B may be implemented through the following step 5011B to step 5014B.
Step 5011B: Obtain an ancient-style text set.
Step 5012B: Extract ancient-style dialog data.

FIG. 5C is an eighteenth schematic flowchart of a dialog processing method for a virtual scene according to an aspect of this application. Step 5011B and step 5012B may be implemented through step 501C to step 505C.
Step 501C: Obtain an ancient-style text set from the Internet.

For example, the ancient-style text set may be extracted from a novel website, for example, a martial arts novel website.
Step 502C: Extract dialog content inside a double quote, and delete an invalid dialog statement, to obtain dialog statements of a plurality of rounds.

For example, a role dialog is generally marked through symbols such as a double quote, a single quote, and a colon. A location of the foregoing dialog content-related symbols in text may be determined, and statement content associated with the symbols is obtained as the dialog content. The invalid dialog statement is a statement with a word quantity less than a word quantity threshold (for example, 2 words) and an occurrence frequency higher than a frequency threshold (for example, 20 times per 10,000 words). For example, onomatopoeias such as “swoosh” and “clang”. Content of such type of dialog statement is generally short. Frequency statistics is performed on a short sentence with a word quantity less than or equal to 2. When any short sentence occurs more than 20 times, and content of the short sentence is onomatopoeia, the short sentence is an invalid dialog statement, and the invalid dialog statement is eliminated from text data.
Step 503C: Extract plot data between every two rounds of dialog statements, to determine a dialog scene.

For example, when a text data volume between two dialog statements exceeds a preset data volume (for example, a preset row quantity (for example, 10 rows), a preset word quantity (for example, 100 words), or a preset sentence quantity (for example, 10 sentences)), the two dialog statements respectively belong to dialogs of different fields. Based on this, text is segmented (that is, grouped above) to obtain a plurality of dialogs, and each dialog includes a plurality of statements.
Step 504C: Extract content preceding the double quote, to obtain a dialog role.

For example, the dialog role is the virtual object above. A segment of text content is used as an example below for explanation and description of obtaining the dialog role.

A specified role said: “When did you know!”

Content in a double quote is content of a dialog statement, and “a specified role said” is preceding content. An entity word representing a name is extracted from the preceding content as a dialog role, and then “a specified role” is the dialog role (the speaking object above).

After the dialog role is obtained, role information of the dialog role may also be corrected and supplied manually.
Step 505C: Perform segmentation and sampling, to obtain training data.

For example, a dialog is used as an example below for explanation and description of performing segmentation and sampling.
(Statement 1) Role C: Are you in business?
(Statement 2) Role D: I am a businessman.
(Statement 3) Role C: What is a purpose of doing business?
(Statement 4) Role D: Of course for making money.

Starting from a last statement in the foregoing dialog, segmentation is performed in sequence. First three statements and the statement 4 are obtained in first segmentation. The statement 4 is used as an output statement, and the first three statements are used as input statements, to form a sample dialog. Second segmentation is performed on the first three statements, and the statement 3 is obtained. The statement 3 is used as an output statement, and the statement 1 and the statement 2 are used as input statements. By analogy, a plurality of samples are obtained based on one dialog.

Refer to FIG. 5B continuously. Step 5013B: Extract role data.

For example, a principle of step 5013B is the same as that of step 504C above, and details are not described herein again.
Step 5014B: Correlate the role data and the dialog data.

For example, the role data and corresponding dialog data are correlated, and each dialog statement corresponds to a virtual object speaking the dialog statement.
Step 502B is performed after step 5014B. Step 502B: Train a model.

For example, a plot generation model (the field dialog model above) is trained based on the ancient-style field dialog data obtained in step 501B.

FIG. 7C is a schematic diagram of a second structure of a to-be-trained model according to an aspect of this application. The to-be-trained model includes a plurality of pre-training model transformer layer 701C (GPT transformer layer), and an example in which there are 12 transformer layers is configured for explanation and description in this aspect of this application. Each pre-training model transformer layer 701C includes an encoder 704C and a decoder 705C. The encoder 704C is configured to encode a sample input statement (for example, when did you know it?), to obtain a key and a value. The decoder 705C is configured to encode a sample output statement (for example, what do you mean?), to obtain a query vector. The query vector, the key, and the value are spliced, transformation of a plurality of layers is performed in the to-be-trained model, a predicted text feature of each sample output statement is obtained through prediction, and the predicted text feature is normalized (softmax), to obtain a probability corresponding to each statement.

The training a model may be implemented in the following manners.

A largest word quantity of a sample input dialog is set to 256, and a largest word quantity of a predicted output statement is set to 128, which may be represented as batch size=128, and a quantity of times of training (epoch) is set to 10. A parameter of the to-be-trained model is loaded, and an entity attribute value model (EVA2.0-large) may be used as the to-be-trained model, to obtain an initialization parameter. Each time batch size text is selected for inference, a batch size group probability feature y is obtained, and a dimension is batchsize*vocab_num, where vocab_num represents a total quantity of predicted words. For example, vocab_num=30000. The to-be-trained model predicts a difference between a predicted probability feature y (the second text feature above) and an actual probability feature y groundtruth (the first text feature above) of the sample output statement, and the difference is used as a prediction loss. Based on the prediction loss, back propagation is performed to update the parameter of the to-be-trained model, so that in each piece of training data, content of the sample input statement is configured for generating a dialog statement of a last round, and continuously approaching the sample output statement in the training data.

Training is repeated until convergence, or when a current quantity-of-times-of-training reaches a set quantity-of-times-of-training (epoch), training is stopped. The set quantity-of-times-of-training may be 10 times. In an entire training fine-tuning process, a plot generation model retains fluency and common sense logic of a general dialog model. In addition, a style and feature of a dialog in an ancient-style field can be learned, to obtain a suitable plot dialog model.

For example, the general dialog model is trained based on massive open source data sets. A general dialog model trained using large-scale general dialog corpus can not only improve fluency and rationality of dialog generation, but also enable the general dialog model to learn a Chinese common sense habit. A function of the general dialog model is to evaluate fluency and quality of a dialog outputted by a plot generation model of a specific style. A principle of training the general dialog model is the same as a principle of training the plot generation model, and details are not described herein again.
Step 503B: Obtain an initial statement, a dialog round threshold, and a smallest word quantity of a statement.

For example, the initial statement may be inputted manually by a plot editor. Alternatively, when the method according to this aspect of this application is applied to a game, the initial statement is manually inputted by a player. Alternatively, a dialog role and a corresponding dialog statement are randomly extracted from a database as the initial statement. The dialog round threshold is a maximum value of a round in a dialog, and may be set to 30. The smallest word quantity of a statement may be set to three words, thereby avoiding occurrence of an invalid statement with extremely less content.
Step 504B: Invoke the plot generation model to generate a plurality of statements corresponding to a plurality of roles.

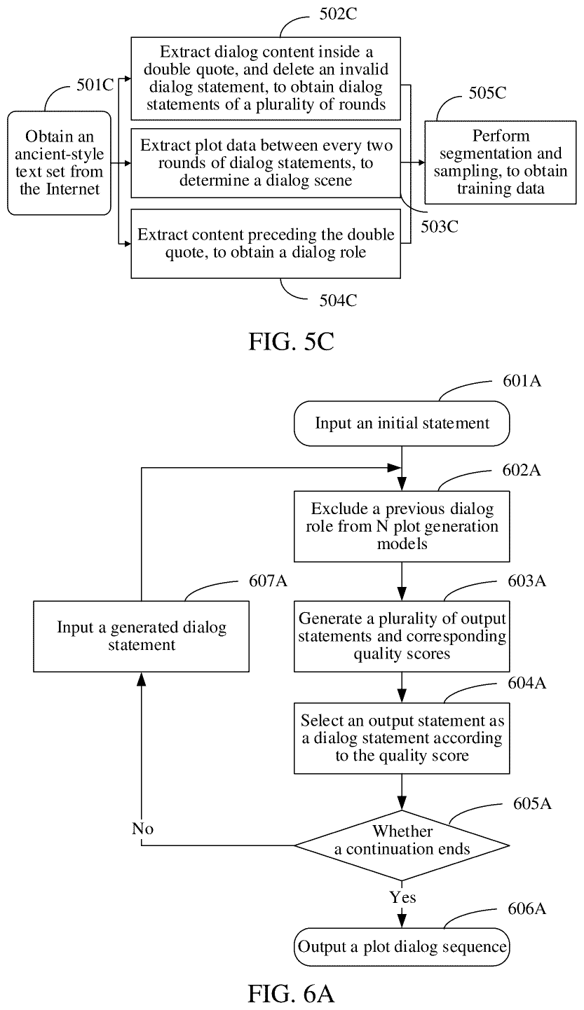

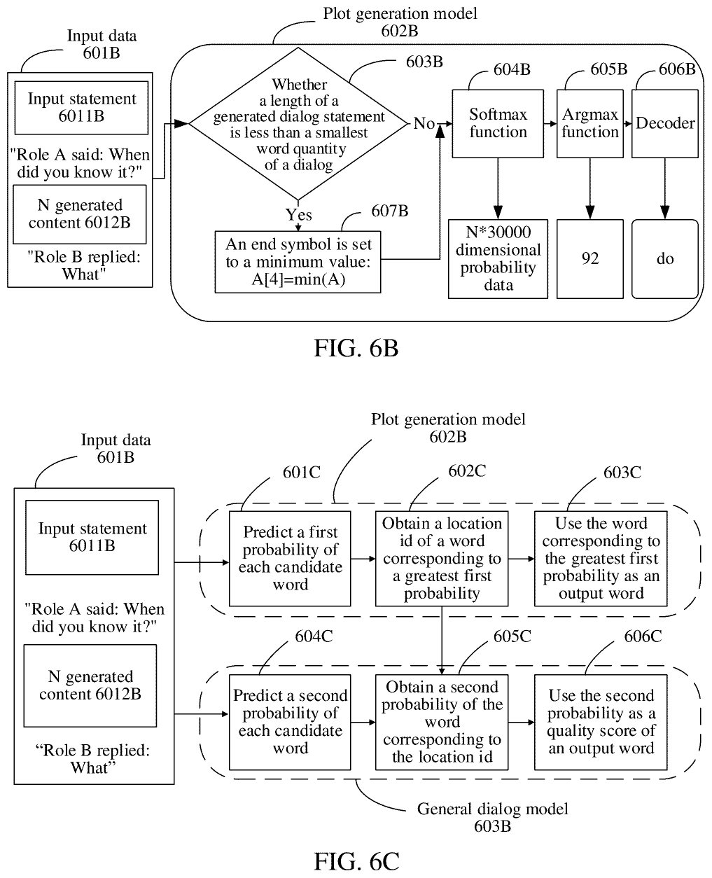

For example, step 504B may be implemented through steps in FIG. 6A. FIG. 6A is a nineteenth schematic flowchart of a dialog processing method for a virtual scene according to an aspect of this application.
Step 601A: Input an initial statement.

For example, for performing of step 601A, reference may be made to step 503B, and details are not described herein again.
Step 602A: Exclude a previous dialog role from N plot generation models.

For example, the previous dialog role is also the participating object above. Each time of dialog generation requires removal of a participating object speaking in the previous round. A user may input a specified participating object. When the user specifies a participating object, an output statement corresponding to a specified role is obtained. When obtaining an output statement of a next round, the specified participating object needs to be excluded to avoid that dialog statements in adjacent rounds are outputted by a plot generation model of a same virtual object, causing the same virtual object to continue to speak, which affects quality of a generated dialog.
Step 603A: Generate a plurality of output statements and corresponding quality scores.

For example, a word list is obtained, and the word list may include a large amount of candidate words, for example, 30,000. The plot generation model predicts, based on the input statement, a probability that each candidate word in the word list is a first word in the output statement. A prediction formula (1) is as follows:

$${y}_{nxet} = tokenizer\_decode ( arg max ( softmax ( gpt ( x , {y}_{pre} ) ) ) ) \qquad ( 1 )$$

In the first round, x is the input statement, and yₚᵣₑ=0, which represents that there is no output word generated currently. yₙₓₑₜ represents an output word obtained through prediction in the first round. gpt(x, yₚᵣₑ) represents that the field dialog model encodes the input statement, to obtain the input statement vector, and a probability feature is obtained through prediction based on the input statement vector. A softmax function normalizes the probability feature to obtain the first prediction probability (a value range is [0, 1]). An argmax function is configured for obtaining an index value corresponding to the greatest first prediction probability in the word list. A tokenizer_decode function is configured for obtaining text of a corresponding candidate word in the word list based on the index value of the greatest first prediction probability, to obtain a candidate word yₙₓₑₜ corresponding to the greatest first prediction probability.

FIG. 6B is a twentieth schematic flowchart of a dialog processing method for a virtual scene according to an aspect of this application. In a plot generation model 602B, step 603B and step 607B are performed. The plot generation model 602B includes a plurality of functions, including a softmax function (604B) and an argmax function (605B). The plot generation model 602B further includes a decoder 606B.

Input data 601B includes: an input statement 6011B (for example, “Role A said: When did you know it?”), and N generated content 6012B (for example, “Role B replied: What” and an output word “What” is content that has been generated).
Step 603B: Determine whether a length of a generated dialog statement is less than a smallest word quantity of a dialog.

When a determination result of step 603B is yes, step 607B is performed, and an end symbol is set to a minimum value: A[4]=min(A). When the determination result is no, the input data is sequentially inputted into the softmax function, the argmax function, and the decoder. If a length of dialog content generated in a current round is less than the set smallest word quantity of the dialog, a value of a sequence number corresponding to the end symbol is set to a minimum value of a current total list. If a data volume of the dialog statement (a row quantity, a word quantity, or a sentence quantity) has reached a set minimum data volume requirement, no value operation for the end symbol is performed. Finally, probability calculation is performed by using a method of normalization function (Softmax) processing, and a word corresponding to a location id with a greatest probability is selected as a continuation of a next word.

Explanation and description are provided based on the foregoing examples. The Softmax function obtains N*30000 dimensional probability data based on the input data. The Argmax function is configured for obtaining a location id corresponding to a candidate word with a greatest probability in the N*30000 dimensional probability data, which is 92 in this aspect of this application. The decoder is configured to decode data corresponding to the location id and obtain a character “do” corresponding to the location id.

In other words, the plot dialog model predicts and obtains a first word “What” in the output statement based on the input statement “When did you know it?”, and predicts and knows a second word “do” in the output statement based on the input statement “When did you know it?”. By analogy, subsequent words in the output statement are obtained.

For ease of explanation of a relationship between the general dialog model and the plot generation model, reference may be made to FIG. 6C. FIG. 6C is a twenty-first schematic flowchart of a dialog processing method for a virtual scene according to an aspect of this application. The plot generation model 602B performs step 601C to step 603C, and the general dialog model 603B performs step 604C to step 606C. The input data 601B has been explained above, and details are not described herein again.
Step 601C: Predict a first probability of each candidate word.

For a principle of step 601C, reference may be made to each step in FIG. 6B above. The first probability is the first prediction probability above.

Execution of step 604C and step 601C may be performed in parallel. Step 604C: Predict a second probability of each candidate word. The second probability is the second prediction probability above.
Step 602C is performed after step 601C. Step 602C: Obtain a location id of a word corresponding to a greatest first probability.

For example, the word list includes 30,000 words. Each word corresponds to a different sequence number (location id). The plot generation model predicts a probability of occurrence of each word in the word list, and a first probability feature of 30,000 dimensions may be obtained. Data of each dimension in the probability feature represents a first probability of a word, and a corresponding location id of a maximum first probability in the first probability feature is obtained.

After step 602C, step 603C and step 605C are performed. Step 603C: Use the word corresponding to the greatest first probability as an output word. Step 605C: Obtain a second probability of the word corresponding to the location id.
Step 606C: Use the second probability as a quality score of an output word.

For example, a location id of text “do” in a probability feature 1 is 92, then a probability corresponding to a location id92 in a probability feature 2 is searched for, and a value of 0.69 is obtained. The probability 0.69 corresponding to the location id92 is used as a quality score of the text “do”.

For example, each output word in an output statement is scored, second probabilities corresponding to the output words are summarized, to obtain a score list, a mean value of scores corresponding to the output words is calculated, and the mean value is regarded as a quality score of the output statement.

Refer to FIG. 6A continuously. Step 604A: Select an output statement as a dialog statement according to the quality score.

For example, a size of the quality score is used as a size of a probability of random selection, the output statements are sorted in descending order according to the quality score, and an output statement is selected as a generated dialog statement from topN (for example, N is 3) output statements.
Step 605A: Determine whether a continuation ends. When a determination result of 605A is yes, step 606A is performed, to output a plot dialog sequence. When the determination result of 605A is no, step 607A is performed, to input a generated dialog statement. After step 607A, step 602A is performed.

For example, a determination condition for the end of the continuation may be whether a quantity of generated dialog statements reaches a preset quantity, or whether a total word quantity of a dialog reaches a preset word quantity.

Refer to FIG. 5B continuously. Step 505B: Invoke the general dialog model to score each statement.
Step 506B: Obtain a dialog statement of a current round and a speaking virtual object according to a score of each statement.
Step 507B: Determine whether to end a continuation or not. When a determination result of step 507B is yes, step 508B is performed, the continuation is ended, and dialog content and a score of each dialog statement are outputted. When the determination result of step 507B is no, step 504B is performed.

For example, for performing of step 505B to step 508B, reference may be made to step 602A to step 607A, and details are not described herein again.

The dialog processing method for a virtual scene according to this aspect of this application may be applied to a game. For example, in a plot game, a plurality of players play different roles, a plurality of virtual objects discuss a specified topic, and a speaking location of each user is provided during a dialog. A plurality of options are provided for each user to choose, each option corresponds to a different sub-task, a subsequent dialog is generated based on an option selected by the user, and a sub-task corresponding to a dialog option is issued to the user.

Alternatively, corresponding dialog content is manually inputted, and the subsequent dialog is generated based on the dialog content inputted by the user, and a sub-task is issued to a role of the user based on the subsequent dialog.

The following technical effects are achieved through this aspect of this application:
1. A martial arts novel with a similar game background is configured for training to learn a dialog generation model that fits a game style, which improves adaptability of a dialog generation model in a game.
2. A factor such as content of the game itself or a plot setting is combined, and a dialog plot that is more in line with game logic is generated by learning a plot in the game.
3. Diversity of plot generation is improved in a manner of dialog generation.
4. Multi-role dialog generation is used, a rigorous dialog evaluation solution is designed, and plot dialog content with a rich scene and story can be generated.

The following continues to describe an exemplary structure of a software module implemented by a dialog processing apparatus 455 for a virtual scene according to an aspect of this application. In some aspects, as shown in FIG. 2, the software module in the dialog processing apparatus 455 for a virtual scene stored in a memory 450 may include: a dialog generation module 4551, configured to invoke, based on at least one input statement, a field dialog model respectively corresponding to at least one participating object of a current round to perform dialog generation, to obtain a plurality of output statements of each participating object, the at least one participating object being a virtual object other than a speaking object of a previous round in the plurality of virtual objects; and a quality detection module 4552, configured to invoke, based on each output statement, a general dialog model to perform quality prediction, to obtain a quality parameter of each output statement, the general dialog model being obtained through training based on dialog samples in a general field, the quality detection module 4552 being configured to select a dialog statement of the current round from the plurality of output statements based on the quality parameter of each output statement.

In some aspects, before the invoking, based on at least one input statement, a field dialog model respectively corresponding to at least one participating object of a current round to perform dialog generation, to obtain a plurality of output statements of each participating object, the dialog generation module 4551 is configured to obtain, in response to that the current round is a first round, an initial statement preset for the current dialog, and use the initial statement as an input statement of the first round; and select, in response to that the current round is a subsequent round after the first round, at least one statement from the following statements as at least one input statement of the subsequent round: the initial statement, and a dialog statement of any round before the current round.

In some aspects, the dialog generation module 4551 is configured to determine, in response to that a type of a dialog statement of the previous round is a question, that a current dialog scene is a question answering scene, and use at least the dialog statement of the previous round as the input statement; and determine, in response to that the type of the dialog statement of the previous round is not a question, that the current dialog scene is a chat scene, and select at least one statement from a dialog statement of any round before the current round and the initial statement as the input statement.

In some aspects, the dialog generation module 4551 is configured to invoke, based on the at least one input statement, the field dialog model of the participating object of the current round to perform statement content prediction, to obtain a plurality of output words; and

perform a plurality of times of selection processing on the plurality of output words sequentially in chronological order, and combine output words obtained through each time of selection processing in chronological order respectively into the output statements, where a selection quantity of a first time of selection processing is one, and selection quantities of the plurality of times of selection processing increase sequentially.

In some aspects, the dialog generation module 4551 is configured to obtain a word list and a largest word quantity N of the output statement, where N is a positive integer, the word list includes a plurality of candidate words and a word encoding vector corresponding to each candidate word; encode the at least one input statement, to obtain an input statement vector corresponding to the at least one input statement; invoke, based on the input statement vector, the field dialog model of the participating object of the current round to perform statement content prediction, to obtain a first prediction probability of each candidate word, and use a candidate word corresponding to a greatest first prediction probability as a 1^{st} output word; and let a value of n gradually increase and satisfy 2≤n≤N−1, and iterate n to perform the following processing: invoking, based on the input statement vector and word encoding vectors of n output words, the field dialog model of the participating object of the current round to perform statement content prediction, to obtain a first prediction probability of each candidate word, and using a candidate word corresponding to a greatest first prediction probability as an (n+1)^{th} output word.

In some aspects, the quality detection module 4552 is configured to perform the following processing for each output statement: invoking, based on the output statement and at least one input statement corresponding to the output statement, the general dialog model to perform quality prediction, to obtain a second prediction probability corresponding to each output word in the output statement; and obtaining a first average value of second prediction probabilities, and using the first average value as the quality parameter of the output statement.

In some aspects, the quality detection module 4552 is configured to obtain a total word quantity M of the output statement and a word encoding vector of each output word in the output statement, where M is a positive integer; obtain an input statement vector of the at least one input statement corresponding to the output statement; invoke, based on the input statement vector of the at least one input statement, the general dialog model to perform statement content prediction, to obtain a second prediction probability corresponding to a 1^{st} output word in the output statement; and let a value of m gradually increase and satisfy 2≤m≤M−1, and iterate m to perform the following processing: invoking, based on the input statement vector of the at least one input statement and word encoding vectors of output words corresponding to m second prediction probabilities, the general dialog model to perform statement content prediction, to obtain a second prediction probability corresponding to an (m+1)^{th} output word in the output statement.

In some aspects, before the invoking, based on at least one input statement, a field dialog model respectively corresponding to at least one participating object of a current round to perform dialog generation, the dialog generation module 4551 is configured to determine the at least one participating object of the current round in at least one of the following manners: obtaining, in a case that the current dialog scene is the question answering scene and the dialog statement of the previous round is an interrogative sentence, at least one piece of role information included by the dialog statement of the previous round, and using at least one virtual object corresponding to the at least one piece of role information as the at least one participating object of the current round; using, in a case that the current dialog scene is the chat scene, at least one virtual object other than the speaking object of the previous round in the plurality of virtual objects as the at least one participating object of the current round; searching for, in a dialog round table, at least one participating object preset for the current round, where the dialog round table includes at least one participating object preset for each dialog round, and participating objects of adjacent rounds in the dialog round table are different; and using, in a descending order result of second average values corresponding to the virtual objects, at least one virtual object corresponding to at least one second average value starting from a first place as the at least one participating object of the current round, where the second average value corresponding to the virtual object is an average value of quality parameters of output statements corresponding to the virtual object.

In some aspects, the quality detection module 4552 is configured to sort the output statements in descending order based on the quality parameters of the output statements, to obtain a descending sorted list; and select any output statement in a preset quantity of output statements at a top of the descending sorted list as the dialog statement of the current round.

In some aspects, after the selecting a dialog statement of the current round from the plurality of output statements based on the quality parameter of each output statement, the dialog generation module 4551 is configured to combine, in response to satisfying a dialog end condition, dialog statements of rounds in chronological order of selection into a dialog sequence, where the dialog end condition includes at least one of the following: a quantity of generated dialog statements reaches a statement quantity threshold; a total dialog content word quantity is greater than a dialog word quantity threshold, where the total dialog content word quantity is a sum of the following parameters: a word quantity of the generated dialog statements, and a word quantity of the input statement of the first round; and field dialog models corresponding to participating objects respectively output at least one dialog statement.

In some aspects, before the invoking, based on at least one input statement, a field dialog model respectively corresponding to at least one participating object of a current round to perform dialog generation, to obtain a plurality of output statements of each participating object, the dialog generation module 4551 is configured to obtain a first sample set of the dialog samples in the particular field, where each dialog sample includes at least one sample input statement, a sample output statement for replying to the at least one sample input statement, and role information of a virtual object that outputs the sample output statement; classify, according to the role information of the virtual object that outputs the sample output statement, the dialog samples in the first sample set, to obtain a first sample subset corresponding to each virtual object, where each sample output statement in the first sample subset corresponds to a same virtual object; and perform the following processing for a to-be-trained model associated with each virtual object: performing iterative training on the to-be-trained model based on the first sample subset corresponding to the virtual object, and using a trained to-be-trained model as a field dialog model corresponding to the virtual object.

In some aspects, the dialog generation module 4551 is configured to obtain text data in the particular field; extract a plurality of sample dialogs from the text data, where each sample dialog includes sample dialog statements of a plurality of rounds; extract role information respectively associated with the plurality of sample dialogs from the text data, where sample dialog statements of adjacent rounds are respectively outputted by different virtual objects; and perform the following processing for each sample dialog: performing a plurality of times of selection processing on the plurality of sample dialog statements in the sample dialog sequentially in chronological order, and combining sample dialog statements obtained through each time of selection processing into a dialog sample in the particular field, where a selection quantity of a first time of selection processing is two, and selection quantities of the plurality of times of selection processing increase sequentially; and in each dialog sample, a last sample dialog statement is a sample output statement, and a sample dialog statement other than the last sample dialog statement is a sample input statement; and combine the dialog samples into the first sample set.

In some aspects, the dialog generation module 4551 is configured to extract text content corresponding to a dialog symbol from the text data, where the dialog symbol includes at least one of the following: a double quote, a single quote, and a colon; use a statement satisfying a screening condition in the text content as the sample dialog statement, where the screening condition includes at least one of the following: a quantity of times of occurrence of the text content is less than a quantity-of-times threshold, and a word quantity of the text content is greater than a word quantity threshold; obtain a text data volume of text content between two adjacent sample dialog statements in the text data, where the text data volume is represented in at least one of the following manners: a text word quantity, a row quantity corresponding to text, and a sentence quantity corresponding to the text; determine, in response to that the text data volume is greater than a data volume threshold, that there is a plot gap between the two adjacent sample dialog statements; and group the plurality of sample dialog statements based on each plot gap, to obtain the plurality of sample dialogs, where each sample dialog includes at least two sample dialog statements.

In some aspects, the dialog generation module 4551 is configured to perform the following processing for a sample dialog statement of each round in each sample dialog: extracting, from the text data, text content between the following two: the sample dialog statement, and a sample dialog statement of a previous round; and extracting a target entity word whose type is an object name from the text content, and using the target entity word as role information of a virtual object associated with the sample dialog statement.

In some aspects, the dialog generation module 4551 is configured to perform the following processing for each dialog sample in the first sample subset: invoking, based on the at least one sample input statement in the dialog sample, the to-be-trained model to perform dialog generation, to obtain a predicted output statement; obtaining a difference between the predicted output statement and the sample output statement in the dialog sample, and using the difference as a prediction loss; performing back propagation on the to-be-trained model based on the prediction loss, to obtain a parameter-updated to-be-trained model; and using the parameter-updated to-be-trained model as the field dialog model corresponding to the virtual object in response to that a quantity of times of back propagation reaches a quantity-of-times-of-training threshold.

In some aspects, the dialog generation module 4551 is configured to encode the at least one sample input statement, to obtain a sample input vector; separately encode the predicted output statement and the sample output statement, to obtain a predicted vector and a sample output vector; splice the sample input vector and the sample output vector, to obtain a first spliced vector, and transform the first spliced vector, to obtain a first text feature of the sample output statement; splice the sample input vector and the predicted vector, to obtain a second spliced vector, and transform the second spliced vector, to obtain a second text feature corresponding to the predicted output statement; and obtain a difference between the first text feature and the second text feature, and use the difference as the prediction loss.

In some aspects, before the invoking, based on at least one input statement, a field dialog model respectively corresponding to at least one participating object of a current round to perform dialog generation, to obtain a plurality of output statements of each participating object, the quality detection module 4552 is configured to obtain a second sample set of the dialog samples in the general field, where each dialog sample includes at least one sample input statement, and a sample output statement for replying to the at least one sample input statement; and perform iterative training on a to-be-trained model based on the second sample set, and use a trained to-be-trained model as a general dialog model.

In some aspects, the quality detection module 4552 is configured to perform the following processing for each dialog sample in the second sample set: invoking, based on the at least one sample input statement in the dialog sample, the to-be-trained model to perform dialog generation, to obtain a predicted output statement; obtaining a difference between the predicted output statement and the sample output statement in the dialog sample, and using the difference as a prediction loss; performing back propagation on the to-be-trained model based on the prediction loss, to obtain a parameter-updated to-be-trained model; and using the parameter-updated to-be-trained model as the general dialog model in response to that a quantity of times of back propagation reaches a quantity-of-times-of-training threshold.

An aspect of this application provides a computer program product, the computer program product including a computer program or computer-executable instructions, the computer program or the computer instructions being stored in a computer-readable storage medium. A processor of a computer device reads the computer-executable instructions from the computer-readable storage medium, and executes the computer-executable instructions, to cause the computer device to perform the foregoing dialog processing method for a virtual scene according to the aspects of this application.

An aspect of this application provides a computer-readable storage medium storing computer-executable instructions, the computer-executable instructions, when executed by a processor, causing the processor to perform the dialog processing method for a virtual scene according to the aspects of this application. For example, the dialog processing method for a virtual scene shown in FIG. 3A.

In some aspects, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some aspects, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, through the aspects of this application, in each round of a dialog, for a plurality of output statements that are generated by invoking a field dialog model in a particular field, quality evaluation is performed through a general dialog model. In this way, it is ensured that a high-quality output dialog is selected as a dialog statement of a corresponding round. In addition, dialog data of a current round is used as an input statement of a next round, which is for guiding dialog generation of the next round, and improving overall quality of dialog content from different rounds of the dialog.

The foregoing descriptions are merely aspects of this application and are not intended to limit the protection scope of this application. Any modification, equivalent replacement, or improvement made without departing from the spirit and range of this application shall fall within the protection scope of this application.

What is claimed is:

1. A dialog processing method for a virtual scene, the method being performed by an electronic device, the virtual scene comprising a plurality of virtual objects participating in a current dialog, each virtual object corresponding to a field dialog model, the field dialog model being obtained through training based on dialog samples in a particular field, the method comprising:
invoking, based on at least one input statement, a field dialog model corresponding to at least one participating virtual object of a current round of the current dialog to perform dialog generation, to obtain a plurality of output statements for each participating virtual object, wherein the at least one participating virtual object is other than a speaking virtual object of a previous round of the current dialog;
invoking, based on each output statement, a general dialog model to perform quality prediction, to obtain a quality parameter of each output statement, the general dialog model being obtained through training based on dialog samples in a general field; and
selecting a dialog statement of the current round from the plurality of output statements based on the quality parameter of each output statement.

2. The method according to claim 1, wherein before the invoking, the method further comprises:
obtaining, for an initial round of dialog, an initial statement preset for the current dialog, and using the initial statement as an input statement of the initial round; and
selecting, in response to the current round being a subsequent round after the initial round, at least one statement from the following statements as at least one input statement of the subsequent round: the initial statement, and a dialog statement of any round before the current round.

3. The method according to claim 2, wherein the selecting at least one statement from the following statements as at least one input statement of the subsequent round comprises:
determining, in response to a type of a dialog statement of the previous round being a question, that a current dialog scene is a question answering scene, and using at least the dialog statement of the previous round as the input statement; and
determining, in response to the type of the dialog statement of the previous round not being a question, that the current dialog scene is a chat scene, and selecting at least one statement from a dialog statement of any round before the current round and the initial statement as the input statement.

4. The method according to claim 1, wherein the invoking the field dialog model comprises:
invoking, based on the at least one input statement, the field dialog model of the participating object of the current round to perform statement content prediction, to obtain a plurality of output words; and
performing a plurality of times of selection processing on the plurality of output words sequentially in chronological order, and combining output words obtained through each time of selection processing in chronological order respectively into the output statements, wherein a selection quantity of a first time of selection processing is one, and selection quantities of the plurality of times of selection processing increase sequentially.

5. The method according to claim 4, wherein the invoking, based on the at least one input statement, comprises:
obtaining a word list and a largest word quantity N of the output statement, wherein N is a positive integer, the word list comprises a plurality of candidate words and a word encoding vector corresponding to each candidate word;
encoding the at least one input statement, to obtain an input statement vector corresponding to the at least one input statement;
invoking, based on the input statement vector, the field dialog model of the participating object of the current round to perform statement content prediction, to obtain a first prediction probability of each candidate word, and using a candidate word corresponding to a greatest first prediction probability as a 1^{st} output word; and
gradually increasing a value of n, where n satisfies 2≤n≤N−1, and iterating n to perform the following processing: invoking, based on the input statement vector and word encoding vectors of n output words, the field dialog model of the participating object of the current round to perform statement content prediction, to obtain a first prediction probability of each candidate word, and using a candidate word corresponding to a greatest first prediction probability as an (n+1)^{th} output word.

6. The method according to claim 1, wherein the invoking, based on each output statement, a general dialog model to perform quality prediction, to obtain a quality parameter of each output statement comprises:
performing for each output statement:
invoking, based on the output statement and at least one input statement corresponding to the output statement, the general dialog model to perform quality prediction, to obtain a second prediction probability corresponding to each output word in the output statement; and
obtaining a first average value of second prediction probabilities, and using the first average value as the quality parameter of the output statement.

7. The method according to claim 6, wherein the invoking, based on the output statement and at least one input statement corresponding to the output statement, the general dialog model comprises:
obtaining a total word quantity M of the output statement and a word encoding vector of each output word in the output statement, wherein M is a positive integer;
obtaining an input statement vector of the at least one input statement corresponding to the output statement;
invoking, based on the input statement vector of the at least one input statement, the general dialog model to perform statement content prediction, to obtain a second prediction probability corresponding to a 1^{st} output word in the output statement; and
gradually increasing a value of m, where m satisfies 2≤m≤M−1, and iterating m to perform the following processing: invoking, based on the input statement vector of the at least one input statement and word encoding vectors of output words corresponding to m second prediction probabilities, the general dialog model to perform statement content prediction, to obtain a second prediction probability corresponding to an (m+1)^{th} output word in the output statement.

8. The method according to claim 1, wherein before invoking the field dialog model the method further comprises:
determining the at least one participating object of the current round in at least one of the following manners:
obtaining, in a case that the dialog statement of the previous round is an interrogative sentence, at least one piece of role information comprised by the dialog statement of the previous round, and using at least one virtual object corresponding to the at least one piece of role information as the at least one participating object of the current round;
using, in a case that the dialog statement of the previous round is a non-interrogative sentence, at least one virtual object other than the speaking object of the previous round in the plurality of virtual objects as the at least one participating object of the current round;
searching for, in a dialog round table, at least one participating object preset for the current round, wherein the dialog round table comprises at least one participating object preset for each dialog round, and participating objects of adjacent rounds in the dialog round table are different; and
using, in a descending order result of second average values corresponding to the virtual objects, at least one virtual object corresponding to at least one second average value starting from a first place as the at least one participating object of the current round, wherein the second average value corresponding to the virtual object is an average value of quality parameters of output statements corresponding to the virtual object.

9. The method according to claim 1, wherein the selecting comprises:
sorting the output statements in descending order based on the quality parameters of the output statements, to obtain a descending sorted list; and
selecting any output statement in a preset quantity of output statements at a top of the descending sorted list as the dialog statement of the current round.

10. The method according to claim 1, wherein after the selecting, the method further comprises:
combining, in response to satisfying a dialog end condition, dialog statements of rounds in chronological order of selection into a dialog sequence, wherein the dialog end condition comprises at least one of the following:
a quantity of generated dialog statements reaches a statement quantity threshold;
a total dialog content word quantity is greater than a dialog word quantity threshold, wherein the total dialog content word quantity is a sum of the following parameters: a word quantity of the generated dialog statements, and a word quantity of the input statement of the first round; and
field dialog models corresponding to participating objects respectively output at least one dialog statement.

11. The method according to claim 1, wherein before the invoking the field dialog models, the method further comprises:
obtaining a first sample set of the dialog samples in the particular field, wherein each dialog sample comprises at least one sample input statement, a sample output statement for replying to the at least one sample input statement, and role information of a virtual object that outputs the sample output statement;
classifying, according to the role information of the virtual object that outputs the sample output statement, the dialog samples in the first sample set, to obtain a first sample subset corresponding to each virtual object, wherein each sample output statement in the first sample subset corresponds to a same virtual object; and
performing the following processing for a to-be-trained model associated with each virtual object: performing iterative training on the to-be-trained model based on the first sample subset corresponding to the virtual object, and using a trained to-be-trained model as a field dialog model corresponding to the virtual object.

12. The method according to claim 11, wherein the obtaining a first sample set of the dialog samples in the particular field comprises:
obtaining text data in the particular field;
extracting a plurality of sample dialogs from the text data, wherein each sample dialog comprises sample dialog statements of a plurality of rounds;
extracting role information respectively associated with the plurality of sample dialogs from the text data, wherein sample dialog statements of adjacent rounds are respectively outputted by different virtual objects; and
performing the following processing for each sample dialog:
performing selection processing on the plurality of sample dialog statements in the sample dialog sequentially in chronological order, and combining sample dialog statements obtained through each time of selection processing into a dialog sample in the particular field, wherein a selection quantity of a first time of selection processing is two, and selection quantities of the plurality of times of selection processing increase sequentially, and in each dialog sample, a last sample dialog statement is a sample output statement, and a sample dialog statement other than the last sample dialog statement is a sample input statement; and
combining the dialog samples into the first sample set.

13. The method according to claim 12, wherein the extracting the plurality of sample dialogs from the text data comprises:
extracting text content corresponding to a dialog symbol from the text data, wherein the dialog symbol comprises at least one of the following: a double quote, a single quote, and a colon;
using a statement satisfying a screening condition in the text content as the sample dialog statement, wherein the screening condition comprises at least one of the following: a quantity of times of occurrence of the text content is less than a quantity-of-times threshold, and a word quantity of the text content is greater than a word quantity threshold;
obtaining a text data volume of text content between two adjacent sample dialog statements in the text data, wherein the text data volume is represented in at least one of the following manners: a text word quantity, a row quantity corresponding to text, and a sentence quantity corresponding to the text;
determining, in response to that the text data volume is greater than a data volume threshold, that there is a plot gap between the two adjacent sample dialog statements; and
grouping the plurality of sample dialog statements based on each plot gap, to obtain the plurality of sample dialogs, wherein each sample dialog comprises at least two sample dialog statements.

14. The method according to claim 12, wherein the extracting role information respectively associated with the plurality of sample dialogs from the text data comprises:
performing the following processing for a sample dialog statement of each round in each sample dialog:
extracting, from the text data, text content between the following two: the sample dialog statement, and a sample dialog statement of a previous round; and
extracting a target entity word whose type is an object name from the text content, and using the target entity word as role information of a virtual object associated with the sample dialog statement.

15. The method according to claim 11, wherein the performing iterative training on the to-be-trained model based on the first sample subset corresponding to the virtual object, and using a trained to-be-trained model as a field dialog model corresponding to the virtual object comprises:
performing the following processing for each dialog sample in the first sample subset:
invoking, based on the at least one sample input statement in the dialog sample, the to-be-trained model to perform dialog generation, to obtain a predicted output statement;
obtaining a difference between the predicted output statement and the sample output statement in the dialog sample, and using the difference as a prediction loss;
performing back propagation on the to-be-trained model based on the prediction loss, to obtain a parameter-updated to-be-trained model; and
using the parameter-updated to-be-trained model as the field dialog model corresponding to the virtual object in response to that a quantity of times of back propagation reaches a quantity-of-times-of-training threshold.

16. The method according to claim 15, wherein the obtaining a difference between the predicted output statement and the sample output statement in the dialog sample, and using the difference as a prediction loss comprises:
encoding the at least one sample input statement, to obtain a sample input vector;
separately encoding the predicted output statement and the sample output statement, to obtain a predicted vector and a sample output vector;
splicing the sample input vector and the sample output vector, to obtain a first spliced vector, and transforming the first spliced vector, to obtain a first text feature of the sample output statement;
splicing the sample input vector and the predicted vector, to obtain a second spliced vector, and transforming the second spliced vector, to obtain a second text feature corresponding to the predicted output statement; and
obtaining a difference between the first text feature and the second text feature, and using the difference as the prediction loss.

17. A dialog processing apparatus for a virtual scene, the virtual scene comprising a plurality of virtual objects participating in a current dialog, each virtual object corresponding to a field dialog model, the field dialog model being obtained through training based on dialog samples in a particular field, and the apparatus comprising:
a dialog generation module, configured to invoke, based on at least one input statement, a field dialog model corresponding to at least one participating virtual object of a current round to perform dialog generation, to obtain a plurality of output statements for each participating object of the plurality of virtual object that did not speak in an immediately previous round; and
a quality detection module, configured to invoke, based on each output statement, a general dialog model to perform quality prediction, to obtain a quality parameter of each output statement, the general dialog model being obtained through training based on dialog samples in a general field,
the quality detection module being configured to select a dialog statement of the current round from the plurality of output statements based on the quality parameter of each output statement.

18. One or more computer readable media storing computer readable instructions that, when executed by a processor, configure a data processing device to perform a dialog processing method for a virtual scene, the virtual scene comprising a plurality of virtual objects participating in a current dialog, each virtual object corresponding to a field dialog model, the field dialog model being obtained through training based on dialog samples in a particular field, the method comprising:
invoking, based on at least one input statement, a field dialog model corresponding to at least one participating object of a current round of dialog to perform dialog generation, to obtain a plurality of output statements corresponding to each of the at least one participating object, the at least one participating object being a virtual object of the plurality of virtual objects that did not speak during a previous round of dialog;
invoking, based on each output statement, a general dialog model to perform quality prediction, to obtain a quality parameter of each output statement, the general dialog model being obtained through training based on dialog samples in a general field; and
selecting a dialog statement of the current round from the plurality of output statements based on the quality parameter of each output statement.

19. The computer readable media according to claim 1, wherein before the invoking, the method further comprises:
obtaining, for an initial round of dialog, an initial statement preset for the current dialog, and using the initial statement as an input statement of the initial round; and
selecting, in response to the current round being a subsequent round after the initial round, at least one statement from the following statements as at least one input statement of the subsequent round: the initial statement, and a dialog statement of any round before the current round.

20. The computer readable media according to claim 2, wherein the selecting at least one statement from the following statements as at least one input statement of the subsequent round comprises:
determining, in response to a type of a dialog statement of the previous round being a question, that a current dialog scene is a question answering scene, and using at least the dialog statement of the previous round as the input statement; and
determining, in response to the type of the dialog statement of the previous round not being a question, that the current dialog scene is a chat scene, and selecting at least one statement from a dialog statement of any round before the current round and the initial statement as the input statement.
